(19) United States
(12) Patent Application Publication
(10) Pub. No.: US 2019/0193520 A1
(43) Pub. Date: Jun. 27, 2019

(54) MOTOR-DRIVEN VEHICLE

(71) Applicant: HONDA MOTOR CO., LTD., Tokyo (JP)

(72) Inventors: Isao Tsunoda, Wako-shi (JP); Osamu Ishida, Wako-shi (JP); Yoshiyuki Takeuchi, Wako-shi (JP); Ryoma Taguchi, Tokyo (JP); Takahiro Ohmi, Tokyo (JP)

(21) Appl. No.: 16/211,489

(22) Filed: Dec. 6, 2018

(30) Foreign Application Priority Data
Dec. 21, 2017 (JP) 2017-245586

(51) Int. Cl. B60H 1/32; B60H 1/00

(52) U.S. Cl. CPC B60H 1/3205; B60H 2001/3285; B60H 1/00385; B60H 1/00921

(57) ABSTRACT

A motor-driven vehicle includes an electric motor, a power storage device, a controller, and a refrigerant circuit. The refrigerant circuit includes a compressor, an outdoor heat exchanger, a first indoor heat exchanger, a first expansion valve, a second expansion valve, and a second indoor heat exchanger. The controller switches a ratio of an amount of pressure reduction of the second expansion valve to an amount of pressure reduction of the first expansion valve with a predetermined temperature as a boundary when a remaining capacity of the power storage device is equal to or greater than a predetermined value.

### CROSS-REFERENCE TO RELATED APPLICATION

Priority is claimed on Japanese Patent Application No. 2017-245586, filed on Dec. 21, 2017, the contents of which are incorporated herein by reference.

### BACKGROUND

### Field of the Invention

The present invention relates to a motor-driven vehicle.

### Background

In a motor-driven vehicle, an electric motor functions as a power generator at the time of braking. That is, rotation of driving wheels is transmitted to an output shaft of the electric motor and electric power is regenerated by the electric motor by rotation of the output shaft. A regenerated alternating current is converted into a direct current by an inverter, and the converted direct current is supplied from the inverter to a power storage device and is stored in the power storage device.

A motor-driven vehicle having a configuration in which an amount of electric power regenerated in an electric motor is limited when a remaining capacity of a power storage device is greater than a predetermined value in order to protect the power storage device from overcharging is known. However, when an amount of electric power regenerated by the electric motor is limited, a regenerative braking force is less than that in a normal state and unease due to change in a braking feeling is caused in an occupant. On the other hand, when limiting of an amount of electric power regenerated during braking is released with priority given to curtailing change in a braking feeling, deterioration of a battery due to overcharging may be caused.

As a countermeasure therefor, a means for increasing power consumption of an electrical load mounted in a motor-driven vehicle (hereinafter referred to as a vehicular air conditioner) when a remaining capacity of the power storage device is greater than a predetermined value at the time of generation of a regenerative braking force has been disclosed.

A method of operating a cooling device that cools a vehicle interior and a heating device that heats the vehicle interior in parallel when the remaining capacity of the power storage device is greater than a predetermined value during regeneration by the electric motor has been disclosed (for example, see Japanese Unexamined Patent Application, First Publication No. 2015-162947).

### SUMMARY

In the vehicular air conditioner described in Japanese Unexamined Patent Application, First Publication No. 2015-162947, a cooling circuit and a heating circuit are completely separated from each other.

On the other hand, a motor-driven vehicle in which cooling and heating of a vehicle interior can be performed using a vehicular air conditioner by providing a heat pump cycle to the vehicular air conditioner is known. However, in such a motor-driven vehicle, an operation of increasing power consumption of the vehicular air conditioner when a remaining capacity of a power storage device is greater than a predetermined value during regeneration by the electric motor has not been disclosed.

An aspect of the invention provides a motor-driven vehicle that can increase power consumption of a vehicular air conditioner including a heat pump cycle when a remaining capacity of a power storage device is greater than a predetermined value during regeneration by an electric motor.

An aspect of the invention is a motor-driven vehicle that includes: an electric motor; a power storage device that is electrically connected to the electric motor; and a controller that controls the electric motor and the power storage device, the motor-driven vehicle including a refrigerant circuit which includes: a compressor that compresses and discharges an intake refrigerant; an outdoor heat exchanger that causes the refrigerant to exchange heat with outdoor air; a first indoor heat exchanger that is disposed between the compressor and the outdoor heat exchanger and causes the refrigerant to exchange heat with indoor air; a first expansion valve that is disposed between the first indoor heat exchanger and the outdoor heat exchanger and is able to decompress the refrigerant; a second expansion valve that is disposed between the outdoor heat exchanger and the compressor and is able to decompress the refrigerant; and a second indoor heat exchanger that is disposed between the second expansion valve and the compressor and causes the refrigerant to exchange heat with indoor air, wherein the controller changes a ratio of an amount of pressure reduction of the second expansion valve to an amount of pressure reduction of the first expansion valve with a predetermined temperature as a boundary when a remaining capacity of the power storage device is equal to or greater than a predetermined value.

Here, when the power storage device is charged with electric power regenerated by the electric motor, increasing power consumption of the motor-driven vehicle to protect the power storage device from overcharging is defined as waste power control in the following description.

According to this motor-driven vehicle, when the remaining capacity of the power storage device becomes equal to or greater than the predetermined value during operation of the compressor, the ratio of the amount of pressure reduction of the second expansion valve to the amount of pressure reduction of the first expansion valve is changed with the predetermined temperature as a threshold by power waste control. Accordingly, for example, it is possible to switch between a first operation in which the amount of pressure reduction of the refrigerant in the second expansion valve is greater and a second operation in which the amount of pressure reduction of the refrigerant in the first expansion valve is greater with the predetermined temperature as a threshold value.

That is, one of the first operation and the second operation can be switched to the other operation with the predetermined temperature as a threshold. Accordingly, it is possible to decrease an efficiency of one of the first operation and the second operation. Accordingly, it is possible to increase power consumption of an air conditioner including the refrigerant circuit to obtain an efficiency equivalent to that before waste power control in one of the first operation and the second operation.

When the power consumption of the air conditioner is greater than the electric power generated by the electric motor, it is possible to prevent overcharging of the power storage device. When the power consumption of the air conditioner is less than the electric power generated by the electric motor, it is possible to decrease a rate of increase of the remaining capacity of the power storage device.

In the motor-driven vehicle, the predetermined temperature may include a first predetermined temperature and a second predetermined temperature which is higher than the first predetermined temperature, and the controller may simultaneously perform heating using the first indoor heat exchanger and decompression using the second expansion valve when a vehicle interior temperature which is requested by a user of the motor-driven vehicle is equal to or higher than the first predetermined temperature and less than the second predetermined temperature.

Accordingly, it is possible to simultaneously perform a heating operation based on heating using the first indoor heat exchanger and the first operation (that is, cooling operation) in which the refrigerant is decompressed by the second expansion valve by waste power control between the first predetermined temperature and the second predetermined temperature. Accordingly, it is possible to decrease an efficiency of one of the heating operation and the cooling operation (that is, a heating efficiency or a cooling efficiency). As a result, it is possible to increase power consumption of the air conditioner in order to obtain an efficiency equivalent to that before waste power control in one of the heating operation and the cooling operation.

In the motor-driven vehicle, the controller may allow an operation efficiency of the refrigerant circuit to be less when the remaining capacity is equal to or greater than the predetermined value than when the remaining capacity is less than the predetermined value.

In this way, it is possible to decrease an efficiency of one of the first operation and the second operation by waste power control of decreasing an operation efficiency of the refrigerant circuit. Accordingly, it is possible to increase power consumption of the air conditioner in order to obtain an efficiency equivalent to that before waste power control in one of the first operation and the second operation.

In the motor-driven vehicle, the predetermined temperature may include a first predetermined temperature and a second predetermined temperature which is higher than the first predetermined temperature, and the controller may perform decompression using the first expansion valve when the vehicle interior temperature which is requested by the user of the motor-driven vehicle is less than the first predetermined temperature and perform decompression using the second expansion valve when the vehicle interior temperature which is requested by the user of the motor-driven vehicle is equal to or greater than the second predetermined temperature.

Accordingly, when the vehicle interior temperature which is requested by the user is less than the first predetermined temperature, it is possible to give priority to a requirement of the user by performing the second operation (that is, the heating operation) based on decompression using the first expansion valve. When the vehicle interior temperature which is requested by the user is equal to or greater than the second predetermined temperature, it is possible to give priority to a requirement of the user by performing the first operation (that is, the cooling operation) based on decompression using the second expansion valve. Accordingly, it is possible to adjust the vehicle interior temperature in response to the requirement of the user and to secure (maintain) marketability of the motor-driven vehicle.

In the motor-driven vehicle, the predetermined temperature may include a first predetermined temperature and a second predetermined temperature which is higher than the first predetermined temperature, and the controller may perform decompression using the first expansion valve when an outdoor air temperature of the motor-driven vehicle is less than the first predetermined temperature and perform decompression using the second expansion valve when the outdoor air temperature of the motor-driven vehicle is equal to or greater than the second predetermined temperature.

Accordingly, when the outdoor air temperature is less than the first predetermined temperature, it is possible to appropriately maintain the indoor air temperature to correspond to the outdoor air temperature by performing the second operation (that is, the heating operation) based on decompression using the first expansion valve.

When the outdoor air temperature is equal to or greater than the second predetermined temperature, it is possible to appropriately maintain the indoor air temperature to correspond to the outdoor air temperature by performing the first operation (that is, the cooling operation) based on decompression using the second expansion valve. Accordingly, it is possible to appropriately maintain the indoor air temperature to correspond to the outdoor air temperature and to secure (maintain) marketability of the motor-driven vehicle.

In the motor-driven vehicle, the predetermined temperature may include a first predetermined temperature and a second predetermined temperature which is higher than the first predetermined temperature, and the controller may perform decompression using the first expansion valve when the vehicle interior temperature of the motor-driven vehicle is less than the first predetermined temperature and perform decompression using the second expansion valve when the vehicle interior temperature of the motor-driven vehicle is equal to or greater than the second predetermined temperature.

Accordingly, when the vehicle interior temperature is less than the first predetermined temperature, it is possible to appropriately maintain the vehicle interior temperature by performing the second operation (that is, the heating operation) based on decompression using the first expansion valve. When the vehicle interior temperature is equal to or greater than the second predetermined temperature, it is possible to appropriately maintain the vehicle interior temperature by performing the first operation (that is, the cooling operation) based on decompression using the second expansion valve. Accordingly, it is possible to appropriately maintain the vehicle interior temperature and to secure (maintain) marketability of the motor-driven vehicle.

In the motor-driven vehicle, the predetermined temperature may include a first predetermined temperature and a second predetermined temperature which is higher than the first predetermined temperature, and a temperature difference between the first predetermined temperature and the second predetermined temperature when the remaining capacity is equal to or greater than the predetermined value may be greater than a temperature difference between the first predetermined temperature and the second predetermined temperature when the remaining capacity is less than the predetermined value.

Accordingly, when the remaining capacity is equal to or greater than the predetermined value, it is possible to enlarge a range in which the first operation and the second operation are performed together by increasing the temperature difference between the first predetermined temperature and the second predetermined temperature. Accordingly, it is possible to decrease an air-conditioning efficiency by making it difficult to switch to only the first operation or the second operation and to increase the power consumption of the air conditioner.

On the other hand, when the remaining capacity is less than the predetermined value, it is possible to narrow the range in which the first operation and the second operation are performed together by decreasing the temperature difference between the first predetermined temperature and the second predetermined temperature. Accordingly, it is possible to increase an air-conditioning efficiency by making it easy to switch to only the first operation or the second operation and to decrease the power consumption of the air conditioner.

In this way, it is possible to freely control the power consumption of the air conditioner depending on when the remaining capacity is equal to or greater than the predetermined value and when the remaining capacity is less than the predetermined value.

In the motor-driven vehicle, the predetermined temperature may include a first predetermined temperature and a second predetermined temperature which is higher than the first predetermined temperature, and a temperature difference between the first predetermined temperature and the second predetermined temperature may be increased based on an increase in the remaining capacity when the remaining capacity is equal to or greater than the predetermined value.

Accordingly, it is possible to enlarge the range in which the first operation and the second operation are performed together by increasing the temperature difference between the first predetermined temperature and the second predetermined temperature based on the increase in the remaining capacity. Accordingly, it is possible to decrease an air-conditioning efficiency to correspond to the increase in the remaining capacity and to increase the power consumption of the air conditioner.

According to the aspect of the invention, it is possible to increase power consumption of a vehicular air conditioner including a heat pump cycle when a remaining capacity of a power storage device is greater than a predetermined value during regeneration by an electric motor.

### BRIEF DESCRIPTION OF THE DRAWINGS

FIG. 1 is a diagram illustrating a configuration of a motor-driven vehicle including a vehicular air conditioner according to an embodiment of the invention;

FIG. 2 is a configuration diagram illustrating a heating operation mode of the vehicular air conditioner according to the embodiment of the invention;

FIG. 3 is a configuration diagram illustrating a cooling operation mode of the vehicular air conditioner according to the embodiment of the invention;

FIG. 4 is a configuration diagram illustrating first waste power control of the motor-driven vehicle according to the embodiment of the invention;

FIG. 5 is a diagram illustrating a refrigerant pressure-enthalpy diagram of the first waste power control of the motor-driven vehicle according to the embodiment of the invention;

FIG. 6 is a diagram illustrating power consumption of the first waste power control of the motor-driven vehicle according to the embodiment of the invention;

FIG. 7 is a configuration diagram illustrating second waste power control of the motor-driven vehicle according to the embodiment of the invention;

FIG. 8 is a diagram illustrating a refrigerant pressure-enthalpy diagram of the second waste power control of the motor-driven vehicle according to the embodiment of the invention;

FIG. 9 is a diagram illustrating power consumption of the second waste power control of the motor-driven vehicle according to the embodiment of the invention;

FIG. 10 is a configuration diagram illustrating third waste power control of the motor-driven vehicle according to the embodiment of the invention;

FIG. 11 is a diagram illustrating a refrigerant pressure-enthalpy diagram of the third waste power control of the motor-driven vehicle according to the embodiment of the invention;

FIG. 12 is a diagram illustrating power consumption of the third waste power control of the motor-driven vehicle according to the embodiment of the invention;

FIG. 13 is a configuration diagram illustrating fourth waste power control of the motor-driven vehicle according to the embodiment of the invention;

FIG. 14 is a diagram illustrating a refrigerant pressure-enthalpy diagram of the fourth waste power control of the motor-driven vehicle according to the embodiment of the invention;

FIG. 15 is a diagram illustrating power consumption of the fourth waste power control of the motor-driven vehicle according to the embodiment of the invention;

FIG. 16 is a configuration diagram illustrating fifth waste power control of the motor-driven vehicle according to the embodiment of the invention;

FIG. 17 is a diagram illustrating a refrigerant pressure-enthalpy diagram of the fifth waste power control of the motor-driven vehicle according to the embodiment of the invention;

FIG. 18 is a diagram illustrating power consumption of the fifth waste power control of the motor-driven vehicle according to the embodiment of the invention;

FIG. 19 is a flowchart illustrating sixth waste power control of the motor-driven vehicle according to the embodiment of the invention;

FIG. 20 is a configuration diagram illustrating a dehumidifying and heating operation mode of the vehicular air conditioner according to the embodiment of the invention;

FIG. 21 is a configuration diagram illustrating seventh waste power control of the motor-driven vehicle according to the embodiment of the invention;

FIG. 22 is a configuration diagram illustrating eighth waste power control of the motor-driven vehicle according to the embodiment of the invention;

FIG. 23 is a graph which is used to calculate an amount of decrease in regenerative power due to an operation of a grille shutter of the motor-driven vehicle according to the embodiment of the invention;

FIG. 24 is a configuration diagram illustrating ninth waste power control of the motor-driven vehicle according to the embodiment of the invention;

FIG. 25 is a configuration diagram illustrating tenth waste power control of the motor-driven vehicle according to the embodiment of the invention;

FIG. 26 is a configuration diagram illustrating eleventh waste power control of the motor-driven vehicle according to the embodiment of the invention;

FIG. 27 is a diagram illustrating a relationship of power consumption with respect to an intake/discharge pressure difference of a compressor and an air-side load (an air-conditioning load) in the motor-driven vehicle according to the embodiment of the invention; and

FIG. 28 is a diagram illustrating a control state in which the vehicular air conditioner of the motor-driven vehicle according to the embodiment of the invention is switched to a first operation and a second operation at a predetermined temperature.

### DESCRIPTION OF THE EMBODIMENTS

An embodiment of the invention will be described below with reference to the accompanying drawings.

In the embodiment, an electric vehicle (a battery electric vehicle (BEV)) is exemplified as a motor-driven vehicle, but the invention is not limited thereto. For example, the invention may be applied to other vehicles such as a hybrid vehicle (HV) and a fuel-cell vehicle (FCV).

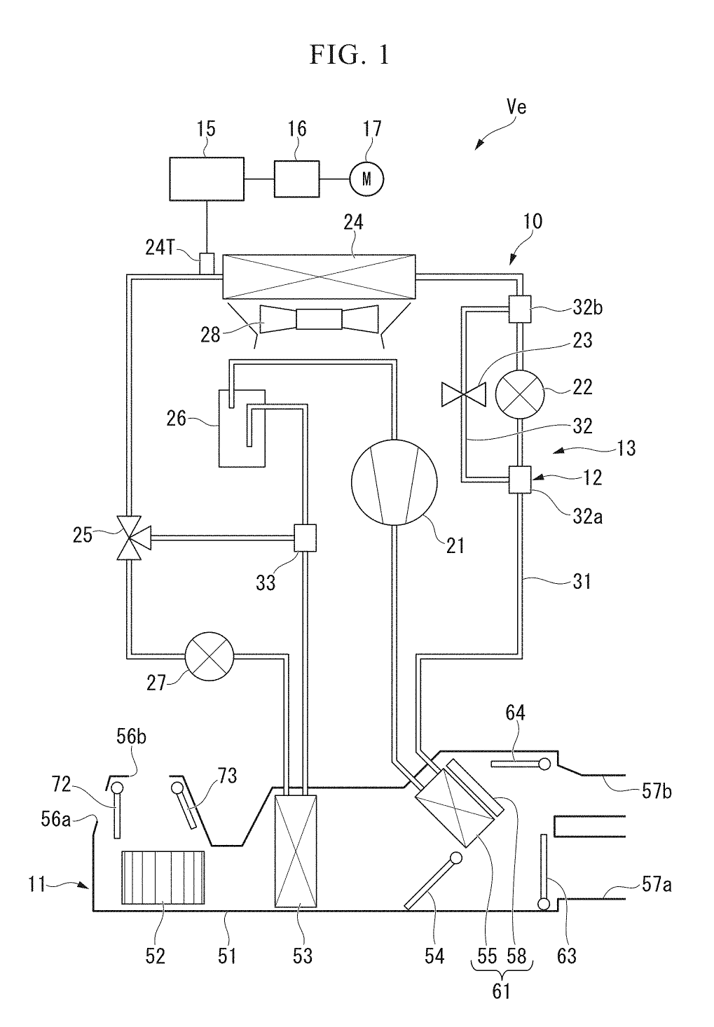

FIG. 1 is a diagram illustrating a configuration of a motor-driven vehicle Ve including a vehicular air conditioner 10.

As illustrated in FIG. 1, the vehicular air conditioner 10 is mounted in a motor-driven vehicle Ve such as an electric vehicle that does not include an engine (an internal combustion engine) as a vehicle drive source. The motor-driven vehicle Ve is an electric vehicle including the vehicular air conditioner 10, a controller 15 (ECU: electronic control unit) 15, a power storage device (a battery) 16, and an electric motor (a traveling motor) 17.

The electric motor 17 is electrically connected to the power storage device 16 via an inverter (not illustrated). When the electric motor 17 is activated, a direct current which is output from the power storage device 16 is converted into an alternating current by the inverter and is supplied to the electric motor 17. By supplying the alternating current to the electric motor 17, the electric motor 17 generates a driving force. When the electric motor 17 generates a driving force, driving wheels are rotationally driven in a driving direction or a reversing direction.

On the other hand, when the motor-driven vehicle Ve is braked, the electric motor 17 functions as a power generator. That is, rotation of the driving wheels is transmitted to an output shaft of the electric motor 17 and electric power is regenerated by the electric motor 17 from rotation of the output shaft. At this time, the electric motor 17 serves as a resistive element and a resistive force acts as a regenerative braking force on the motor-driven vehicle Ve. An alternating current regenerated by the electric motor 17 is converted into a direct current by the inverter. The converted direct current is supplied from the inverter to the power storage device 16 and is stored in the power storage device 16.

The vehicular air conditioner 10 is mounted in the motor-driven vehicle Ve. The vehicular air conditioner 10 mainly includes an air-conditioning unit 11 and a heat pump cycle 12 in which a refrigerant can circulate.

The air-conditioning unit 11 includes a duct 51 in which conditioning air flows, a blower 52, a second indoor heat exchanger (an evaporator) 53, a first air guide unit (an air mix door) 54, and a first indoor heat exchanger 61. The blower 52, the second indoor heat exchanger 53, a first air guide unit 54, and the first indoor heat exchanger 61 are accommodated in the duct 51.

The duct 51 includes air inlets 56a and 56b and air outlets 57a and 57b.

The blower 52, the second indoor heat exchanger 53, the first air guide unit 54, and the first indoor heat exchanger 61 are sequentially arranged from upstream (the air inlets 56a and 56b side) in a flowing direction of conditioning air in the duct 51 to downstream (the air outlets 57a and 57b side).

The air inlet 56a constitutes an indoor air inlet that takes in indoor air. The air inlet 56b constitutes an outdoor air inlet that takes in outdoor air. The air inlet 56a is opened and closed by an indoor air door 72. The air inlet 56b is opened and closed by an outdoor air door 73. For example, by adjusting apertures of the indoor air door 72 and the outdoor air door 73 under the control of the controller 15, a flow rate ratio between indoor air and outdoor air that flow into the duct 51 may be adjusted.

The air outlet 57a constitutes a VENT outlet. The air outlet 57b constitutes a DEF outlet. The air outlet 57a is formed to be opened and closed by a VENT door 63. The air outlet 57b is formed to be opened and closed by a DEF door 64. In the air outlets 57a and 57b, air proportions that are blown out from the air outlets 57a and 57b are adjusted, for example, by switching between opening and closing of the VENT door 63 and the DEF door 64 under the control of the controller 15.

The blower 52 is driven by a motor, for example, depending on a drive voltage which is applied to the motor under the control of the controller 15. The blower 52 sends conditioning air (at least one of indoor air and outdoor air) which flows from the air inlets 56a and 56b to the duct 51 downstream, that is, to the second indoor heat exchanger 53 and the first indoor heat exchanger 61.

The second indoor heat exchanger 53 causes exchange of heat to be performed between a low-pressure refrigerant flowing thereinto and a vehicle interior atmosphere (in the duct 51) and cools conditioning air passing through the second indoor heat exchanger 53, for example, by absorbing heat when the refrigerant is evaporated.

The first indoor heat exchanger 61 includes an indoor condenser 55 and a heat-radiating unit 58. The indoor condenser 55 can exchange heat with a compressed refrigerant with a high temperature and a high pressure which flows thereinto.

The indoor condenser 55 heats conditioning air passing through the indoor condenser 55, for example, by radiating heat.

The heat-radiating unit 58 is disposed downstream from the indoor condenser 55 and is connected to the power storage device 16. The heat-radiating unit 58 is electrically heated with power supplied from the power storage device 16. An example of the heat-radiating unit 58 is a positive temperature coefficient (PTC) heater. The heat-radiating unit 58 is not limited to a PTC heater and other heat-radiating units may be employed.

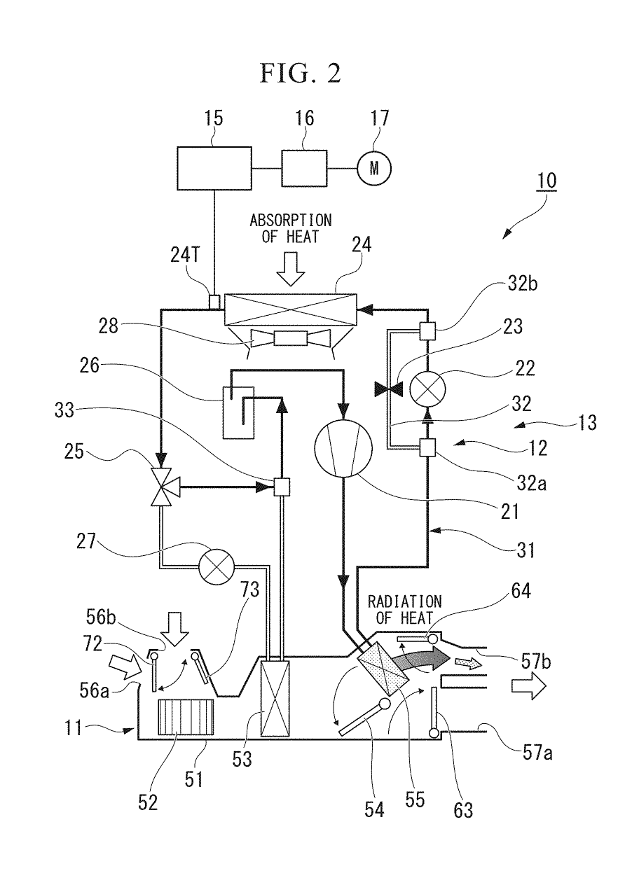

In FIGS. 2 to 26, the heat-radiating unit 58 is not illustrated for the purpose of easy understanding of the configuration.

The first air guide unit 54 is operated to swing, for example, under the control of the controller 15. The first air guide unit 54 swings between a heating position at which an air flow passage from downstream of the second indoor heat exchanger 53 to the indoor condenser 55 in the duct 51 is open and a cooling position at which an air flow passage bypassing through the indoor condenser 55 is open. Accordingly, in the conditioning air passing through the second indoor heat exchanger 53, an air volume ratio between an air volume which is introduced into the indoor condenser 55 and an air volume which bypasses the indoor condenser 55 and is discharged into the vehicle interior is adjusted.

The heat pump cycle 12 includes, for example, the second indoor heat exchanger 53, the indoor condenser 55, a compressor 21 that compresses a refrigerant, a first expansion valve (a heating decompression valve) 22, a cooling electromagnetic valve 23, an outdoor heat exchanger 24, a three-way valve 25, a gas-liquid separator 26, and a second expansion valve (a cooling decompression valve) 27. The constituent members of the heat pump cycle 12 are connected via a refrigerant flow passage 31. The refrigerant flow passage 31 is a flow passage in which a refrigerant can circulate.

A refrigerant circuit 13 is constituted by the heat pump cycle 12, the second indoor heat exchanger 53, and the indoor condenser 55. That is, the refrigerant circuit 13 is provided in the motor-driven vehicle Ve.

The compressor 21 is connected between the gas-liquid separator 26 and the indoor condenser 55, takes in a refrigerant on the gas-liquid separator 26 side, and discharges the refrigerant to the indoor condenser 55 side. The compressor 21 is driven by a motor, for example, based on a drive voltage applied to the motor under the control of the controller 15. The compressor 21 takes in a gas refrigerant (a refrigerant gas) from the gas-liquid separator 26, compresses the refrigerant, and discharges a high-temperature and high-pressure refrigerant to the indoor condenser 55.

The first expansion valve 22 and the cooling electromagnetic valve 23 are arranged in parallel downstream from the indoor condenser 55 in the refrigerant flow passage 31.

The first expansion valve 22 is, for example, a throttle valve of which an aperture can be adjusted. The first expansion valve 22 decompresses and expands a refrigerant having passed through the indoor condenser 55 and discharges the refrigerant as a mist-like refrigerant of two phases of gas and liquid (which is liquid phase-rich) with a low temperature and a low pressure to the outdoor heat exchanger 24.

The cooling electromagnetic valve 23 connects a first branch portion 32a and a second branch portion 32b provided on both sides of the first expansion valve 22 in the refrigerant flow passage 31 and is provided in a bypass flow passage 32 which bypasses the first expansion valve 22. The cooling electromagnetic valve 23 is opened and closed, for example, under the control of the controller 15. The cooling electromagnetic valve 23 is closed when a heating operation is performed and is opened when a cooling operation is performed.

Accordingly, for example, when a heating operation is performed, a refrigerant discharged from the indoor condenser 55 is greatly decompressed in the first expansion valve 22 and flows into the outdoor heat exchanger 24 in a low-temperature and low-pressure state. On the other hand, when a cooling operation is performed, a refrigerant discharged from the indoor condenser 55 passes through the cooling electromagnetic valve 23 and flows into the outdoor heat exchanger 24 in a high-temperature state.

The outdoor heat exchanger 24 is disposed in a vehicle exterior and performs heat exchange between the refrigerant flowing thereinto and the vehicle exterior atmosphere. An outlet temperature sensor 24T that detects a temperature of a refrigerant flowing from the outlet of the outdoor heat exchanger 24 (a refrigerant outlet temperature Tout) is provided downstream from the outdoor heat exchanger 24. A signal indicating the refrigerant temperature detected by the outlet temperature sensor 24T is input to the controller 15. The signal input from the outlet temperature sensor 24T to the controller 15 is used to determine execution of a variety of air-conditioning control in the controller 15.

When a heating operation is performed, the outdoor heat exchanger 24 can absorb heat from the vehicle exterior atmosphere using the low-temperature and low-pressure refrigerant flowing thereinto and increases the temperature of the refrigerant by absorption of heat from the vehicle exterior atmosphere. On the other hand, when a cooling operation is performed, the outdoor heat exchanger 24 can radiate heat to the vehicle exterior atmosphere using the high-temperature refrigerant flowing thereinto and cools the refrigerant by radiation of heat to the vehicle exterior atmosphere and blowing of a second air guide unit 28.

An example of the second air guide unit 28 is a condenser fan that controls a passing-through air volume of the outdoor heat exchanger 24 and, for example, a grille shutter may be used as another example. When the second air guide unit 28 is a condenser fan, the condenser fan is driven, for example, based on a drive voltage applied to a motor of the condenser fan under the control of the controller 15.

The three-way valve 25 switches the refrigerant flowing out of the outdoor heat exchanger 24 to the gas-liquid separator 26 or the second expansion valve (the cooling decompression valve) 27 and discharges the refrigerant. Specifically, the three-way valve 25 is connected to the outdoor heat exchanger 24, a merging portion 33 disposed on the gas-liquid separator 26 side, and the second expansion valve 27, and a flowing direction of the refrigerant is changed, for example, under the control of the controller 15.

When a heating operation is performed, the three-way valve 25 discharges the refrigerant flowing out of the outdoor heat exchanger 24 to the merging portion 33 on the gas-liquid separator 26 side. On the other hand, when a cooling operation is performed, the three-way valve 25 discharges the refrigerant flowing out of the outdoor heat exchanger 24 to the second expansion valve 27.

The gas-liquid separator 26 is connected between the merging portion 33 and the compressor 21 in the refrigerant flow passage 31, separates a gas from a liquid in the refrigerant flowing out of the merging portion 33, and introduces (returns) the gas refrigerant (a refrigerant gas) into the compressor 21.

The second expansion valve 27 is a so-called throttle valve and is connected between the three-way valve 25 and an inlet of the second indoor heat exchanger 53. The second expansion valve 27 decompresses and expands the refrigerant flowing out of the three-way valve 25, for example, based on a valve aperture controlled by the controller 15 and then discharges the refrigerant as a mist-like refrigerant of two phases of gas and liquid (which is liquid phase-rich) with a low temperature and a low pressure to the second indoor heat exchanger 53.

The second indoor heat exchanger 53 is connected between the second expansion valve 27 and the merging portion 33 (the gas-liquid separator 26).

The controller 15 performs air-conditioning control using a refrigerant in the air-conditioning unit 11 and the heat pump cycle 12. The controller 15 controls the vehicular air conditioner 10 based on a command signal input from an operator via a switch or the like (not illustrated) which is disposed in the vehicle interior. The controller 15 controls the electric motor 17 and the power storage device 16 and can perform control of switching an operation mode of the vehicular air conditioner 10 to a heating operation mode, a cooling operation mode, or the like.

Information of a state of charge (SOC) which is a charging rate of the power storage device 16 or a chargeable power which is calculated based on the SOC is input to the controller 15. The chargeable power is the electric power with which the power storage device 16 can be charged. The chargeable power can be acquired, for example, from a table in which the chargeable power decreases as the SOC increases and is 0 at an upper limit of the SOC in order to prevent overcharging of the power storage device 16.

The controller 15 determines whether a remaining capacity of the power storage device 16 is equal to or greater than a predetermined value based on the chargeable power. Information of regenerative power supplied to the power storage device 16 is input to the controller 15.

The controller 15 has a function of controlling the electric motor 17, the vehicular air conditioner 10, the compressor 21, the second air guide unit (a fan) 28, and the like. For example, when the remaining capacity of the power storage device 16 is equal to or greater than the predetermined value at the time of regeneration in the heating operation mode, the controller 15 can operate the compressor 21 and select and control the first expansion valve 22, the second air guide unit 28, and the first air guide unit 54.

When the remaining capacity of the power storage device 16 is equal to or greater than the predetermined value, the controller 15 can perform control of switching the operation mode to a cooling operation (a first operation) and a heating operation (a second operation) with a predetermined temperature as a threshold. When the remaining capacity of the power storage device 16 is equal to or greater than the predetermined value, the controller 15 can perform control such that a difference between a first predetermined temperature and a second predetermined temperature which are included in the predetermined temperature is greater than a difference between the first predetermined temperature and the second predetermined temperature when the remaining capacity of the power storage device 16 is less than the predetermined value.

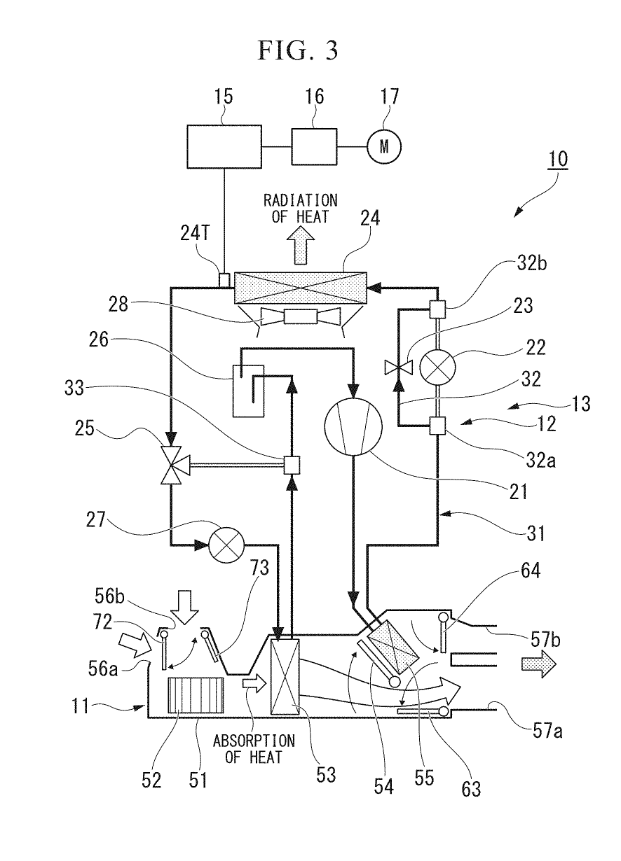

Operations of the vehicular air conditioner 10 in the heating operation mode and the cooling operation mode will be described below with reference to FIGS. 2 and 3. First, the heating operation mode of the vehicular air conditioner 10 will be described with reference to FIG. 2.

(Heating Operation Mode)

As illustrated in FIG. 2, when a heating operation is performed using the vehicular air conditioner 10, the first air guide unit 54 is located at a heating position at which an air flowing path to the indoor condenser 55 is open. The cooling electromagnetic valve 23 is closed and the three-way valve 25 connects the outdoor heat exchanger 24 and the merging portion 33. In the example illustrated in FIG. 2, the DEF door 64 in the air-conditioning unit 11 is opened and the VENT door 63 is closed, but opening and closing thereof can be arbitrarily changed by an operator's operation.

In this case, in the heat pump cycle 12, the high-temperature and high-pressure refrigerant discharged from the compressor 21 heats conditioning air in the duct 51 of the air-conditioning unit 11 by radiation of heat in the indoor condenser 55.

The refrigerant having passed through the indoor condenser 55 is expanded (decompressed) into a liquid phase-rich mist-like state by the first expansion valve 22 and then is caused to undergo heat exchange (absorb heat from the vehicle exterior atmosphere) by the outdoor heat exchanger 24 to be brought into a gas phase-rich mist-like state. The refrigerant having passed through the outdoor heat exchanger 24 passes through the three-way valve 25 and the merging portion 33 and flows into the gas-liquid separator 26. The refrigerant flowing into the gas-liquid separator 26 is separated into a gas phase and liquid phase and the refrigerant of a gas phase flows into the compressor 21.

In a state in which the refrigerant flows in the refrigerant flow passage 31 of the heat pump cycle 12 in this way, the blower 52 of the air-conditioning unit 11 is driven. Accordingly, conditioning air flows into the duct 51 of the air-conditioning unit 11, and the conditioning air passes through the second indoor heat exchanger 53 and then passes through the indoor condenser 55.

Then, the conditioning air exchanges heat with the indoor condenser 55 at the time of passing through the indoor condenser 55 and is supplied as heating air to the vehicle interior via the air outlet 57b.

In a heating operation, the heat-radiating unit 58 (see FIG. 1) in addition to the indoor condenser 55 may be overheated. In the heating operation, only the heat-radiating unit 58 (see FIG. 1) may be overheated instead of the indoor condenser 55.

The cooling operation mode of the vehicular air conditioner 10 will be described below with reference to FIG. 3.

(Cooling Operation Mode)

As illustrated in FIG. 3, when a cooling operation is performed using the vehicular air conditioner 10, the first air guide unit 54 is located at a cooling position at which conditioning air having passed through the second indoor heat exchanger 53 bypasses the indoor condenser 55. The cooling electromagnetic valve 23 is opened (the first expansion valve 22 is closed) and the three-way valve 25 connects the outdoor heat exchanger 24 and the second expansion valve 27. In the example illustrated in FIG. 3, in the air-conditioning unit 11, the DEF door 64 is closed and the VENT door 63 is opened, and opening and closing thereof can be arbitrarily changed by a driver's operation.

In this case, in the heat pump cycle 12, the high-temperature and high-pressure refrigerant discharged from the compressor 21 passes through the indoor condenser 55 and the cooling electromagnetic valve 23, radiates heat to the vehicle exterior atmosphere in the outdoor heat exchanger 24, and then flows into the second expansion valve 27. At this time, the refrigerant is expanded into a liquid phase-rich mist-like state by the second expansion valve 27 and then cools the conditioning air in the duct 51 of the air-conditioning unit 11 by absorbing heat in the second indoor heat exchanger 53.

The refrigerant which is gas phase-rich having passed through the second indoor heat exchanger 53 passes through the merging portion 33, flows into the gas-liquid separator 26, and is separated into gas and liquid in the gas-liquid separator 26, and then the gas-phase refrigerant flows into the compressor 21.

In this way, when the blower 52 of the air-conditioning unit 11 is driven in a state in which the refrigerant flows in the refrigerant flow passage 31, the conditioning air flows into the duct 51 of the air-conditioning unit 11 and exchanges heat with the second indoor heat exchanger 53 at the time of passing through the second indoor heat exchanger 53. Thereafter, the conditioning air bypasses the indoor condenser 55 and then is supplied as cooling air to the vehicle interior via the VENT outlet (that is, an air outlet) 57a.

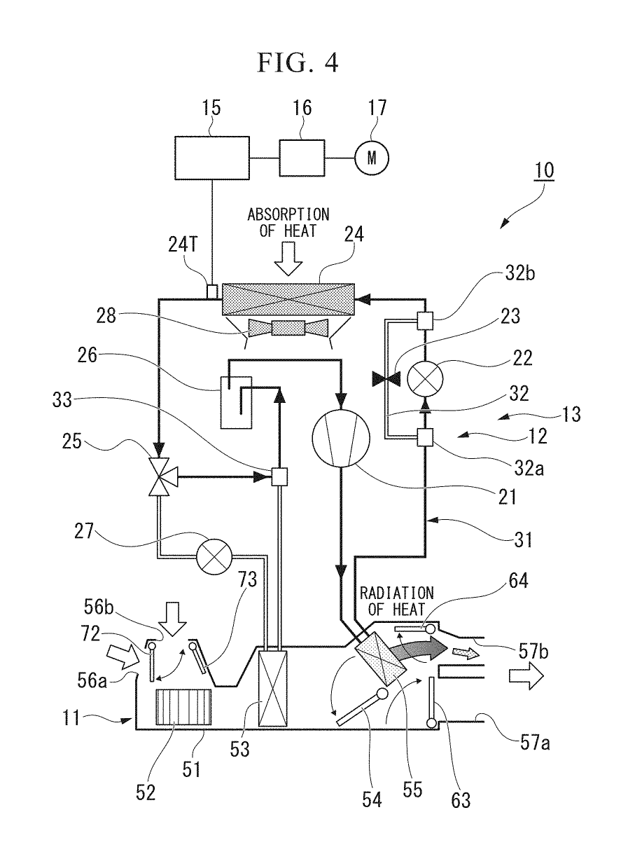

An example in which power waste control is performed using the vehicular air conditioner 10 such that the remaining capacity of the power storage device 16 is not greater than the predetermined value when regenerative electric power is stored in the power storage device 16 in the heating operation mode of the vehicular air conditioner 10 will be described below with reference to FIGS. 4 to 19. First to sixth power waste controls can be used as the power waste control of the vehicular air conditioner 10 in the heating operation mode. The first to sixth power waste controls will be sequentially described below.

First, an example in which power consumption of the vehicular air conditioner 10 is increased by controlling the compressor 21 and the second air guide unit 28 of the vehicular air conditioner 10 as the first power waste control will be described with reference to FIGS. 4 to 6.

(First Power Waste Control)

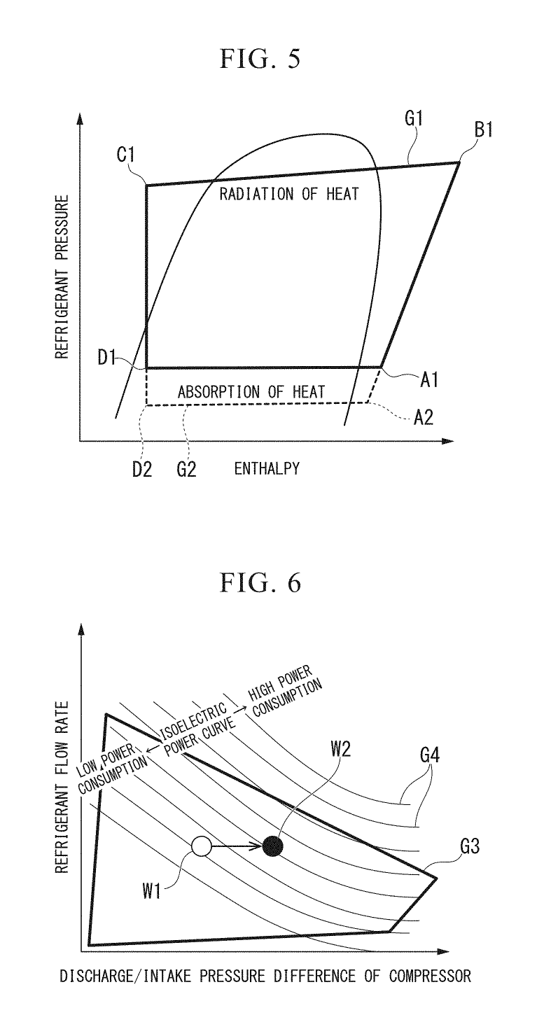

FIG. 5 illustrates a refrigerant pressure-enthalpy diagram, where the vertical axis represents a refrigerant pressure and the horizontal axis represents an enthalpy. In FIG. 5, a refrigerant pressure-enthalpy diagram G1 before the power waste control has been performed in the heating operation mode is indicated by a solid line. In the refrigerant pressure-enthalpy diagram G1, point A1→point B1 represents a refrigerant state change in the compressor 21. Point B1→point C1 represents a refrigerant state change in the indoor condenser 55. Point C1→point D1 represents a refrigerant state change in the first expansion valve 22. Point D1→point A1 represents a refrigerant state change in the outdoor heat exchanger 24.

A refrigerant pressure-enthalpy diagram G2 after the power waste control has been performed is indicated by a dotted line. In the refrigerant pressure-enthalpy diagram G2, point A2→point B1 represents a refrigerant state change in the compressor 21. Point B1→point C1 represents a refrigerant state change in the indoor condenser 55. Point C1→point D2 represents a refrigerant state change in the first expansion valve 22. Point D2→point A2 represents a refrigerant state change in the outdoor heat exchanger 24.

FIG. 6 illustrates a relationship between a heating operation range of the vehicular air conditioner 10 and an isoelectric power curve, where the vertical axis represents a refrigerant flow rate and the horizontal axis represents a discharge/intake pressure difference of the compressor. In FIG. 6, a heating operation range of the vehicular air conditioner 10 is indicated by a diagram G3 and the isoelectric power curve is indicated by a diagram G4. W1 denotes power consumption of the vehicular air conditioner 10 before the power waste control has been performed. W2 denotes power consumption of the vehicular air conditioner 10 after the power waste control has been performed.

As illustrated in FIG. 4, when the remaining capacity of the power storage device 16 is equal to or greater than the predetermined value, the controller 15 controls the second air guide unit 28 such that a passing-through air volume of the second air guide unit 28 is less than a passing-through air volume of the second air guide unit 28 when the remaining capacity of the power storage device 16 is less than the predetermined value.

That is, when the second air guide unit 28 is a condenser fan, the passing-through air volume of the second air guide unit 28 is decreased by decreasing a rotation speed of the fan or stopping the rotation of the fan. When the second air guide unit 28 is a grille shutter, the passing-through air volume of the second air guide unit 28 is decreased by decreasing a gap of the grille shutter or closing the grille shutter.

The passing-through air volume of the outdoor heat exchanger 24 is decreased by decreasing the passing-through air volume of the second air guide unit 28. Accordingly, absorption of heat by the refrigerant flowing into the outdoor heat exchanger 24 is decreased. As a result, the refrigerant which is liquid phase-rich from the outdoor heat exchanger 24 passes through the gas-liquid separator 26 and a gas-phase refrigerant flows into the compressor 21.

Accordingly, as illustrated in FIGS. 4 and 5, an intake refrigerant pressure of the compressor 21 decreases in comparison with before the power waste control has been performed, and an intake refrigerant density decreases to decrease the refrigerant flow rate in order to obtain the same heating capability as before the power waste control has been performed. That is, by decreasing the passing-through air volume of the outdoor heat exchanger, it is possible to decrease an efficiency of the heating operation.

In this state, in order to obtain the same heating capability as before the power waste control has been performed, it is necessary to increase the rotation speed of the compressor 21 to increase the refrigerant flow rate. By increasing the rotation speed of the compressor 21, the power consumption in the compressor 21 increases from W1 to W2 as illustrated in FIGS. 4 and 6 and it is possible to secure an amount of waste power of the vehicular air conditioner 10.

Accordingly, in the first power waste control, when the power consumption W2 of the compressor 21 is greater than the electric power generated by the electric motor 17, it is possible to prevent overcharging of the power storage device 16. When the power consumption W2 of the compressor 21 is less than the electric power generated by the electric motor 17, it is possible to decrease a rate of increase of the remaining capacity of the power storage device 16.

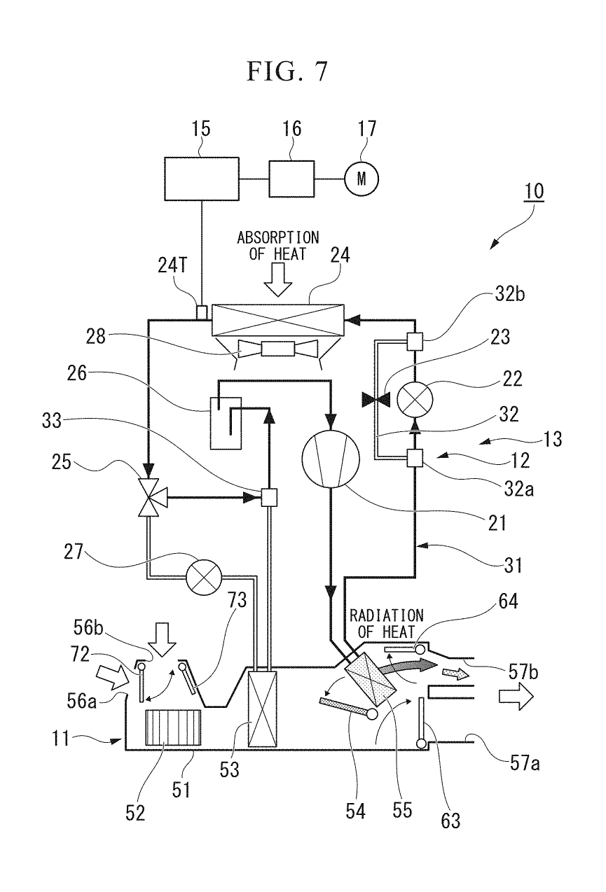

An example in which power consumption of the vehicular air conditioner 10 is increased by controlling the compressor 21 and the first air guide unit 54 of the vehicular air conditioner 10 as second power waste control will be described with reference to FIGS. 7 to 9.

(Second Power Waste Control)

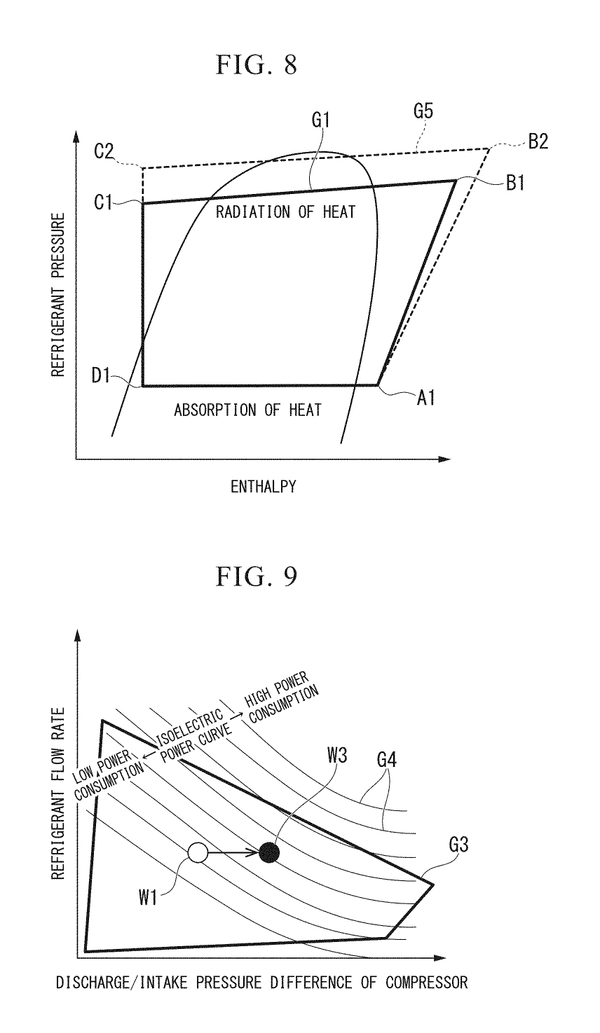

FIG. 8 illustrates a refrigerant pressure-enthalpy diagram, where the vertical axis represents a refrigerant pressure and the horizontal axis represents an enthalpy. In FIG. 8, a refrigerant pressure-enthalpy diagram G1 before the power waste control has been performed in the heating operation mode is indicated by a solid line. The refrigerant pressure-enthalpy diagram G1 before the power waste control has been performed is the same diagram as illustrated in FIG. 5 in the first power waste control.

A refrigerant pressure-enthalpy diagram G5 after the power waste control has been performed is indicated by a dotted line. In the refrigerant pressure-enthalpy diagram G5, point A1→point B2 represents a refrigerant state change in the compressor 21. Point B2→point C2 represents a refrigerant state change in the indoor condenser 55. Point C2→point D1 represents a refrigerant state change in the first expansion valve 22. Point D1→point A1 represents a refrigerant state change in the outdoor heat exchanger 24.

In FIG. 9, diagrams G3 and G4 are the same as diagrams illustrated in FIG. 6 in the first power waste control. That is, in FIG. 9, a heating operation range of the vehicular air conditioner 10 is indicated by a diagram G3 and an isoelectric power curve is indicated by a diagram G4. The vertical axis represents a refrigerant flow rate and the horizontal axis represents a discharge/intake pressure difference of the compressor. In FIG. 9, W1 denotes power consumption of the vehicular air conditioner 10 before the power waste control has been performed. W3 denotes power consumption of the vehicular air conditioner 10 after the power waste control has been performed.

As illustrated in FIG. 7, when the remaining capacity of the power storage device 16 is equal to or greater than the predetermined value, the controller 15 controls the first air guide unit 54 such that a passing-through air volume of the first air guide unit 54 is less than a passing-through air volume of the first air guide unit 54 when the remaining capacity of the power storage device 16 is less than the predetermined value. The passing-through air volume of the indoor condenser 55 is decreased by decreasing the passing-through air volume of the first air guide unit 54. That is, an air volume which is supplied as heating air to the vehicle interior is decreased. Accordingly, it is possible to decrease an efficiency of the heating operation in comparison with before the power waste control has been performed.

In this state, in order to obtain the same heating capability as before the power waste control has been performed, it is necessary to increase the rotation speed of the compressor 21 to increase the refrigerant flow rate as illustrated in FIGS. 7 and 8. By increasing the rotation speed of the compressor 21, the power consumption of the compressor 21 increases from W1 to W3 and it is possible to secure an amount of waste power of the vehicular air conditioner 10 as illustrated in FIGS. 7 and 9.

Accordingly, in the second power waste control, when the power consumption W3 of the compressor 21 is greater than the electric power generated by the electric motor 17, it is possible to prevent overcharging of the power storage device 16. When the power consumption W3 of the compressor 21 is less than the electric power generated by the electric motor 17, it is possible to decrease a rate of increase of the remaining capacity of the power storage device 16.

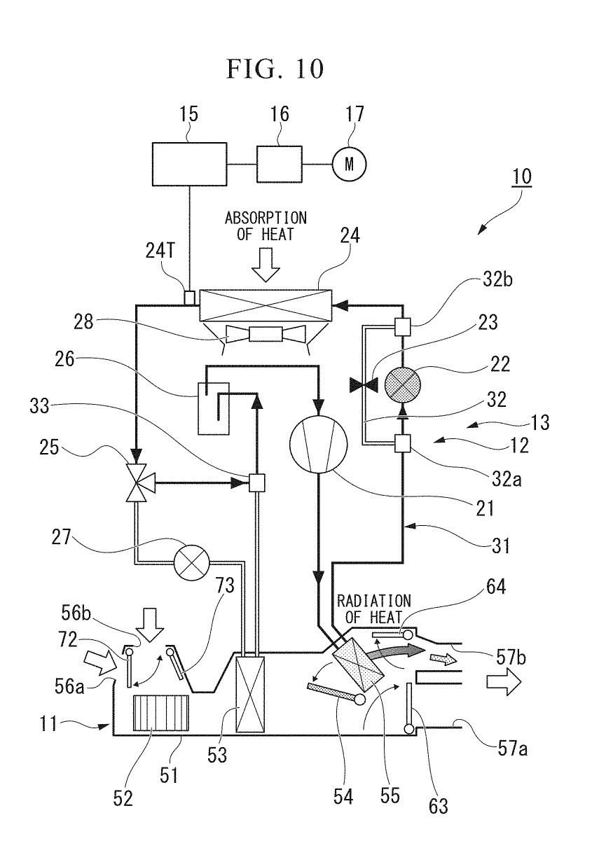

An example in which power consumption of the vehicular air conditioner 10 is increased by controlling the first expansion valve 22 in addition to the compressor 21 and the first air guide unit 54 of the vehicular air conditioner 10 as third power waste control will be described with reference to FIGS. 10 to 12.

(Third Power Waste Control)

In the third power waste control, the power consumption of the vehicular air conditioner 10 is increased by adding control of the first expansion valve 22 to the second power waste control.

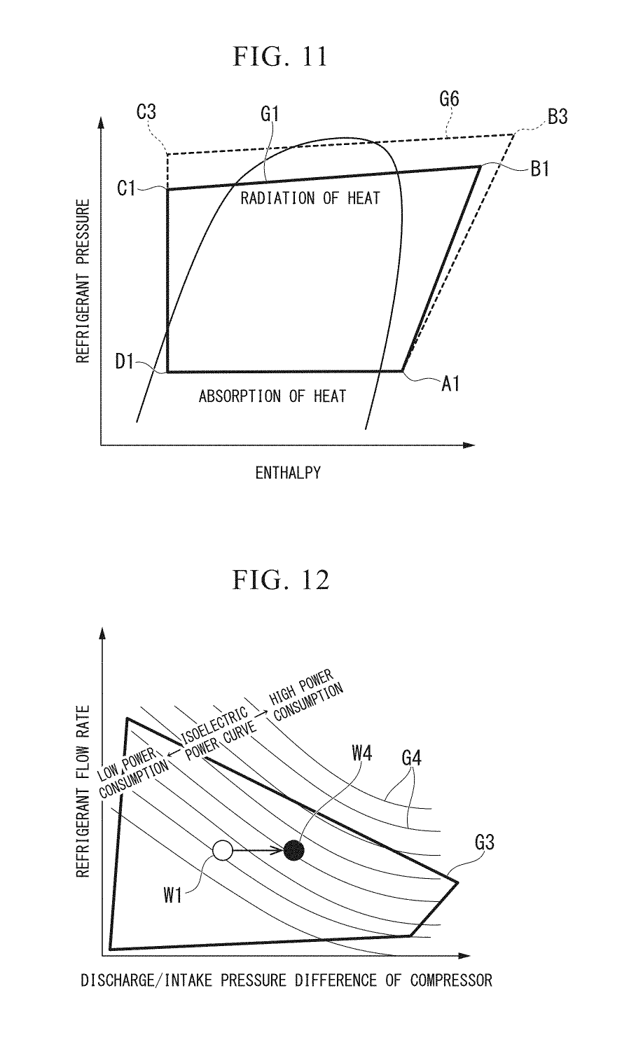

FIG. 11 illustrates a refrigerant pressure-enthalpy diagram, where the vertical axis represents a refrigerant pressure and the horizontal axis represents an enthalpy. In FIG. 11, a refrigerant pressure-enthalpy diagram G1 before the power waste control has been performed in the heating operation mode is indicated by a solid line. The refrigerant pressure-enthalpy diagram G1 before the power waste control has been performed is the same diagram as illustrated in FIG. 5 in the first power waste control.

A refrigerant pressure-enthalpy diagram G6 after the power waste control has been performed is indicated by a dotted line. In the refrigerant pressure-enthalpy diagram G6, point A1→point B3 represents a refrigerant state change in the compressor 21. Point B3→point C3 represents a refrigerant state change in the indoor condenser 55. Point C3→point D1 represents a refrigerant state change in the first expansion valve 22. Point D1→point A1 represents a refrigerant state change in the outdoor heat exchanger 24.

In FIG. 12, diagrams G3 and G4 are the same as illustrated in FIG. 6 in the first power waste control. That is, in FIG. 12, a heating operation range of the vehicular air conditioner 10 is indicated by a diagram G3 and an isoelectric power curve is indicated by a diagram G4.

The vertical axis represents a refrigerant flow rate and the horizontal axis represents a discharge/intake pressure difference of the compressor. In FIG. 12, W1 denotes power consumption of the vehicular air conditioner 10 before the power waste control has been performed. W4 denotes power consumption of the vehicular air conditioner 10 after the power waste control has been performed.

As illustrated in FIG. 10, when the remaining capacity of the power storage device 16 is equal to or greater than the predetermined value, the controller 15 controls the first air guide unit 54 such that a passing-through air volume of the first air guide unit 54 is decreased similarly to the second power waste control. The controller 15 performs control such that an aperture of the first expansion valve 22 is less than the aperture of the first expansion valve 22 when the remaining capacity of the power storage device 16 is less than the predetermined value.

By decreasing the aperture of the first expansion valve 22, the discharge refrigerant pressure of the compressor 21 becomes greater in comparison with before the power waste control has been performed. Accordingly, the compression efficiency of the compressor 21 decreases, the refrigerant flow rate decreases, and thus it is possible to decrease the efficiency of the heating operation.

In this state, in order to obtain the same heating capability as before the power waste control has been performed, it is necessary to increase the rotation speed of the compressor 21 by the second power waste control and to increase the flow rate of the refrigerant discharged from the compressor 21 in comparison with before the second power waste control has been performed as illustrated in FIGS. 10 and 11. By increasing the rotation speed of the compressor 21, the power consumption of the compressor 21 increases from W1 to W4 and it is possible to secure an amount of waste power of the vehicular air conditioner 10 as illustrated in FIGS. 10 and 12.

Accordingly, in the third power waste control, when the power consumption W4 of the compressor 21 is greater than the electric power generated by the electric motor 17, it is possible to prevent overcharging of the power storage device 16. When the power consumption W4 of the compressor 21 is less than the electric power generated by the electric motor 17, it is possible to decrease a rate of increase of the remaining capacity of the power storage device 16.

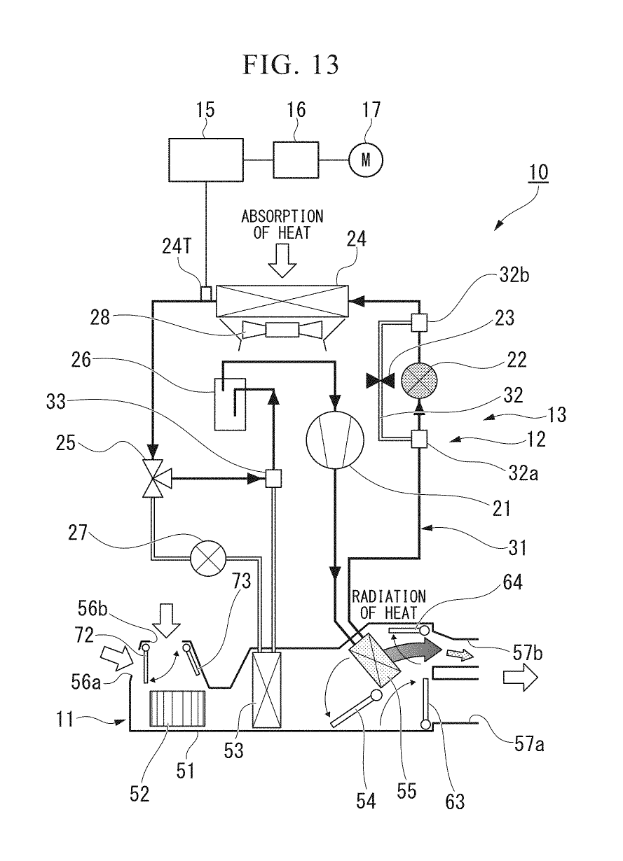

An example in which power consumption of the vehicular air conditioner 10 is increased by controlling the compressor 21 and the first expansion valve 22 of the vehicular air conditioner 10 as fourth power waste control will be described with reference to FIGS. 13 to 15.

(Fourth Power Waste Control)

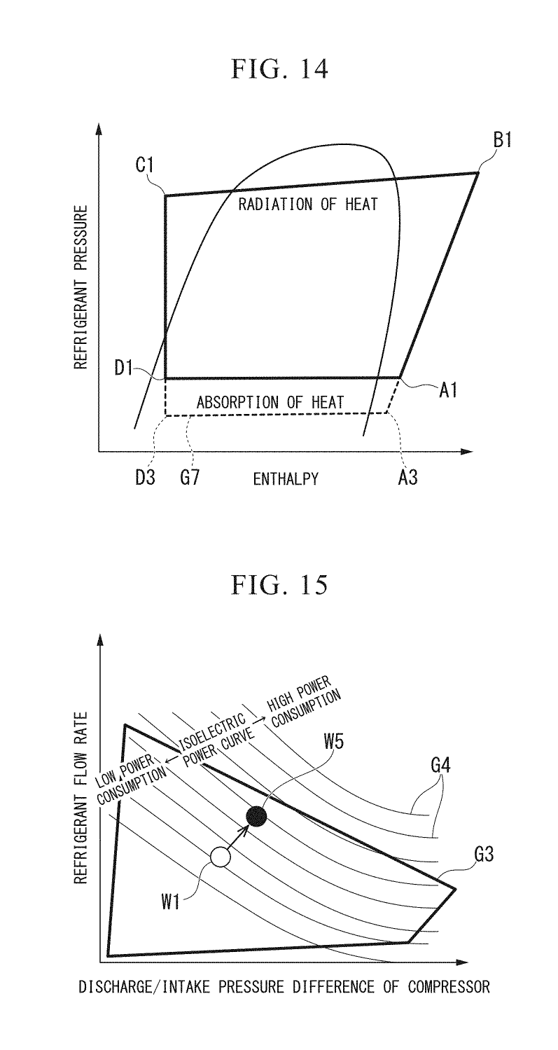

FIG. 14 illustrates a refrigerant pressure-enthalpy diagram, where the vertical axis represents a refrigerant pressure and the horizontal axis represents an enthalpy. In FIG. 14, a refrigerant pressure-enthalpy diagram G1 before the power waste control has been performed in the heating operation mode is indicated by a solid line. The refrigerant pressure-enthalpy diagram G1 before the power waste control has been performed is the same diagram as illustrated in FIG. 5 in the first power waste control.

A refrigerant pressure-enthalpy diagram G7 after the power waste control has been performed is indicated by a dotted line. In the refrigerant pressure-enthalpy diagram G7, point A3→point B1 represents a refrigerant state change in the compressor 21. Point B1→point C1 represents a refrigerant state change in the indoor condenser 55. Point C1→point D3 represents a refrigerant state change in the first expansion valve 22. Point D3→point A3 represents a refrigerant state change in the outdoor heat exchanger 24.

In FIG. 15, diagrams G3 and G4 are the same as illustrated in FIG. 6 in the first power waste control. That is, in FIG. 15, a heating operation range of the vehicular air conditioner 10 is indicated by a diagram G3 and an isoelectric power curve is indicated by a diagram G4.

The vertical axis represents a refrigerant flow rate and the horizontal axis represents a discharge/intake pressure difference of the compressor. In FIG. 15, W1 denotes power consumption of the vehicular air conditioner 10 before the power waste control has been performed. W5 denotes power consumption of the vehicular air conditioner 10 after the power waste control has been performed.

As illustrated in FIG. 13, when the remaining capacity of the power storage device 16 is equal to or greater than the predetermined value, the controller 15 controls the first expansion valve 22 such that the aperture of the first expansion valve 22 is greater than the aperture of the first expansion valve 22 when the remaining capacity of the power storage device 16 is less than the predetermined value. By increasing the aperture of the first expansion valve 22, a refrigerant passing-through area of the first expansion valve 22 is increased. Accordingly, as illustrated in FIGS. 13 and 14, the discharge refrigerant pressure of the compressor 21 becomes less than that before the power waste control has been performed. Accordingly, it is possible to decrease an efficiency of the heating operation of the vehicular air conditioner 10 in comparison with before the power waste control has been performed.

In this state, in order to obtain the same heating capability as before the power waste control has been performed, it is necessary to increase the pressure of the refrigerant which is supplied to the indoor condenser 55. That is, it is necessary to increase the rotation speed of the compressor 21 to increase the flow rate of the refrigerant which is discharged from the compressor 21. By increasing the rotation speed of the compressor 21, the power consumption of the compressor 21 increases from W1 to W5 and it is possible to secure an amount of waste power of the vehicular air conditioner 10 as illustrated in FIGS. 13 and 15.

Accordingly, in the fourth power waste control, when the power consumption W5 of the compressor 21 is greater than the electric power generated by the electric motor 17, it is possible to prevent overcharging of the power storage device 16. When the power consumption W5 of the compressor 21 is less than the electric power generated by the electric motor 17, it is possible to decrease a rate of increase of the remaining capacity of the power storage device 16.

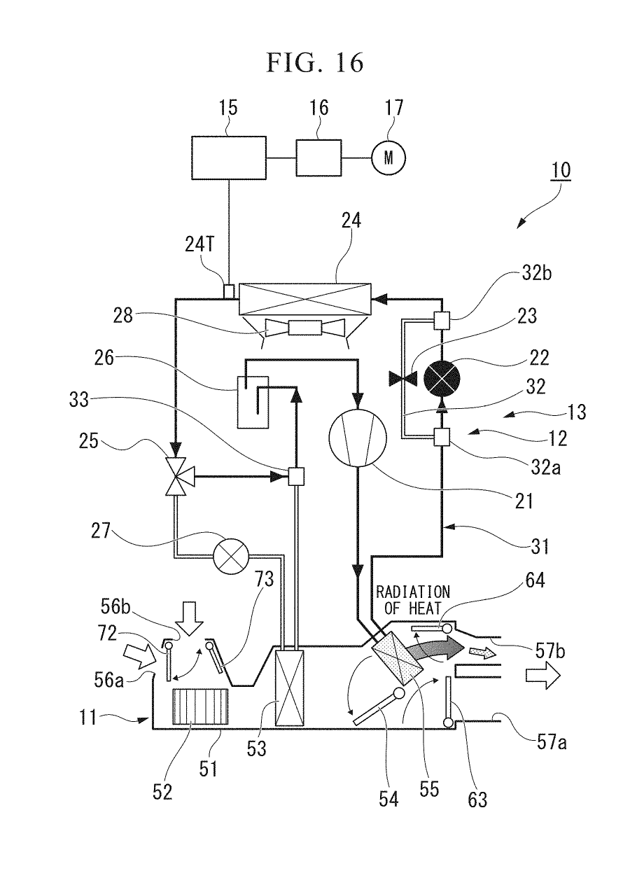

An example in which power consumption of the vehicular air conditioner 10 is increased by controlling the aperture of the first expansion valve 22 such that it is brought into a fully open state from the state in the fourth power waste control as fifth power waste control will be described with reference to FIGS. 16 to 18.

(Fifth Power Waste Control)

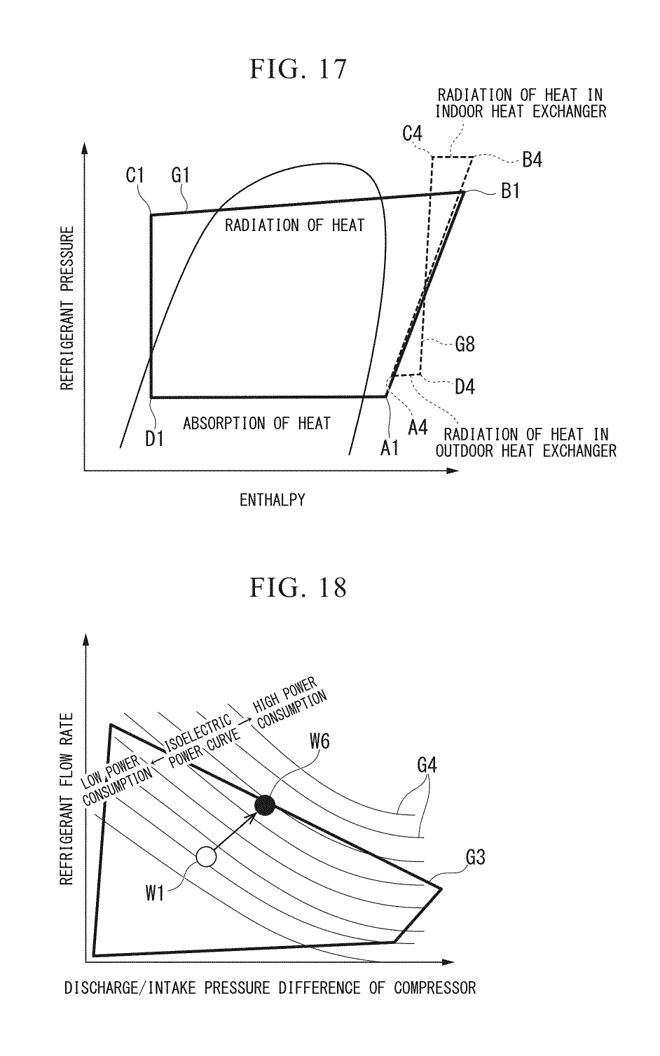

FIG. 17 illustrates a refrigerant pressure-enthalpy diagram, where the vertical axis represents a refrigerant pressure and the horizontal axis represents an enthalpy. In FIG. 17, a refrigerant pressure-enthalpy diagram G1 before the power waste control has been performed in the heating operation mode is indicated by a solid line. The refrigerant pressure-enthalpy diagram G1 before the power waste control has been performed is the same diagram as illustrated in FIG. 5 in the first power waste control.

A refrigerant pressure-enthalpy diagram G8 after the power waste control has been performed is indicated by a dotted line. In the refrigerant pressure-enthalpy diagram G8, point A4→point B4 represents a refrigerant state change in the compressor 21. Point B4→point C4 represents a refrigerant state change in the indoor condenser 55. Point C4→point D4 represents a refrigerant state change in the first expansion valve 22. Point D4→point A4 represents a refrigerant state change in the outdoor heat exchanger 24.

In FIG. 18, diagrams G3 and G4 are the same as illustrated in FIG. 6 in the first power waste control. That is, in FIG. 18, a heating operation range of the vehicular air conditioner 10 is indicated by a diagram G3 and an isoelectric power curve is indicated by a diagram G4.

The vertical axis represents a refrigerant flow rate and the horizontal axis represents a discharge/intake pressure difference of the compressor. In FIG. 18, W1 denotes power consumption of the vehicular air conditioner 10 before the power waste control has been performed. W6 denotes power consumption of the vehicular air conditioner 10 after the power waste control has been performed.

As illustrated in FIG. 16, the controller 15 controls the aperture of the first expansion valve 22 such that it is brought into a fully open state from the state in the fourth power waste control when the remaining capacity of the power storage device 16 is equal to or greater than the predetermined value. By increasing the aperture of the first expansion valve 22 to a fully open state, the refrigerant passing-through area of the first expansion valve 22 is increased to the maximum. In comparison with before the power waste control has been performed, the heating operation mode of the vehicular air conditioner 10 transitions to a hot-gas operation as indicated by the diagram G8 in FIG. 17 and absorption of heat by the outdoor heat exchanger 24 is not possible. That is, work of the compressor 21 (see FIG. 16) becomes equivalent to the heating capability.

Accordingly, as illustrated in FIGS. 16 and 17, in order to secure the same heating capability of the vehicular air conditioner 10 as before the power waste control has been performed, it is necessary to increase the rotation speed of the compressor 21 in comparison with that in the fourth power waste control. By increasing the rotation speed of the compressor 21, the discharge pressure of the refrigerant discharged from the compressor 21 increases and the flow rate of the refrigerant increases. Accordingly, it is possible to secure the same heating capability as before the power waste control has been performed.

On the other hand, by increasing the rotation speed of the compressor 21 in comparison with that in the fourth power waste control, the power consumption of the compressor 21 increases from W1 to W6 and it is possible to secure an amount of waste power of the vehicular air conditioner 10 as illustrated in FIGS. 16 and 18.

Accordingly, in the fifth power waste control, when the power consumption W6 of the compressor 21 is greater than electric power generated by the electric motor 17, it is possible to prevent overcharging of the power storage device 16. When the power consumption W6 of the compressor 21 is less than electric power generated by the electric motor 17, it is possible to decrease a rate of increase of the remaining capacity of the power storage device 16.

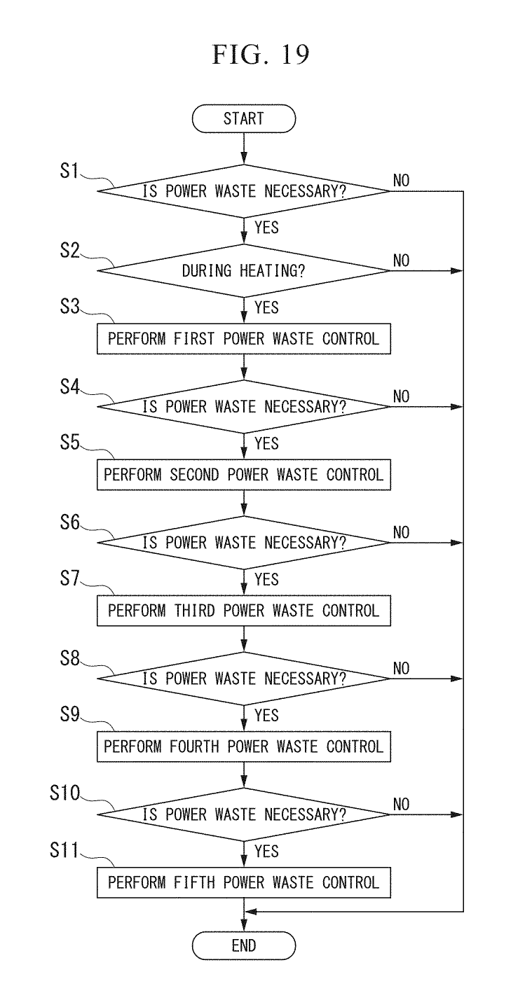

An example in which the power consumption of the vehicular air conditioner 10 is increased by performing the first to fifth power waste controls of the vehicular air conditioner 10 sequentially from one having the lowest power consumption as sixth power waste control will be described below with reference to the flowchart illustrated in FIG. 19.

(Sixth Power Waste Control)

It is assumed that the power consumptions (that is, the amounts of waste power) W2 to W6 in the first to fifth power waste controls satisfy, for example, a relationship of the first amount of waste power W2<the second amount of waste power W3<the third amount of waste power W4<the fourth amount of waste power W5<the fifth amount of waste power W6. The first to fifth amounts of waste power W2 to W6 differ depending on specifications of the motor-driven vehicle Ve.

As illustrated in FIG. 19, for example, when the motor-driven vehicle Ve is traveling on a long downhill road in the heating operation mode and the motor-driven vehicle Ve is braked, rotation of the driving wheels is transmitted to the output shaft of the electric motor 17 and electric power is regenerated by the electric motor 17 due to the rotation of the output shaft. An alternating current regenerated by the electric motor 17 is converted into a direct current by the inverter. The converted direct current is supplied from the inverter to the power storage device 16 and is stored in the power storage device 16.

In this state, in Step S1, the controller 15 determines whether the remaining capacity of the power storage device 16 is equal to or greater than a predetermined value (that is, power waste is necessary) based on chargeable power. When it is determined that power waste is not necessary, the power waste control ends. On the other hand, when it is determined that power waste is necessary, the routine transitions to Step S2. In Step S2, the controller 15 determines whether the vehicular air conditioner 10 is in the heating operation mode.

When it is determined that the vehicular air conditioner 10 is not in the heating operation mode, the power waste control ends. On the other hand, when it is determined that the vehicular air conditioner 10 is in the heating operation mode, the routine transitions to Step S3. In Step S3, the first power waste control is performed. That is, the power consumption of the vehicular air conditioner 10 is increased from W1 to W2 by controlling the compressor 21 and the second air guide unit 28 of the vehicular air conditioner 10.

In this state, in Step S4, the controller 15 determines whether the remaining capacity of the power storage device 16 is equal to or greater than a predetermined value (that is, power waste is necessary) based on chargeable power. When it is determined that power waste is not necessary, the power waste control ends. On the other hand, when it is determined that power waste is necessary, the routine transitions to Step S5. In Step S5, the second power waste control is performed. That is, the power consumption of the vehicular air conditioner 10 is increased from W2 to W3 by controlling the compressor 21 and the first air guide unit 54 of the vehicular air conditioner 10.

In this state, in Step S6, the controller 15 determines whether the remaining capacity of the power storage device 16 is equal to or greater than a predetermined value (that is, power waste is necessary) based on chargeable power. When it is determined that power waste is not necessary, the power waste control ends. On the other hand, when it is determined that power waste is necessary, the routine transitions to Step S7. In Step S7, the third power waste control is performed. That is, the power consumption of the vehicular air conditioner 10 is increased from W3 to W4 by controlling the first expansion valve 22 in addition to the compressor 21 and the first air guide unit 54 of the vehicular air conditioner 10.

In this state, in Step S8, the controller 15 determines whether the remaining capacity of the power storage device 16 is equal to or greater than a predetermined value (that is, power waste is necessary) based on chargeable power. When it is determined that power waste is not necessary, the power waste control ends. On the other hand, when it is determined that power waste is necessary, the routine transitions to Step S9. In Step S9, the fourth power waste control is performed. That is, the power consumption of the vehicular air conditioner 10 is increased from W4 to W5 by controlling the compressor 21 and the first expansion valve 22 of the vehicular air conditioner 10.

In this state, in Step S10, the controller 15 determines whether the remaining capacity of the power storage device 16 is equal to or greater than a predetermined value (that is, power waste is necessary) based on chargeable power. When it is determined that power waste is not necessary, the power waste control ends. On the other hand, when it is determined that power waste is necessary, the routine transitions to Step S11. In Step S11, the fifth power waste control is performed. That is, the power consumption of the vehicular air conditioner 10 is increased from W5 to W6 by controlling the aperture of the first expansion valve 22 such that it is brought into the fully open state from the state in the fourth power waste control. In this way, by sequentially selecting and performing the first to fifth power waste controls from one having the lowest power consumption to one having the highest power consumption, it is possible to prevent excessive waste of the regenerative power.

As described above with Steps S1 to S11 in FIG. 19, the controller 15 controls the vehicular air conditioner 10 depending on the magnitude of electric power regenerated by the electric motor (traveling motor) 17 when the remaining capacity of the power storage device 16 is equal to or greater than a predetermined value. Specifically, the first expansion valve 22, the second air guide unit 28, and the first air guide unit 54 are selected and controlled at the same time as operating the compressor 21. Accordingly, it is possible to decrease the efficiency of the heating operation depending on the amount of regenerative electric power.

In this way, by performing the first to fifth power waste controls having different amounts of waste power sequentially from one having the lowest amount of waste power, it is possible to prevent excessive power waste and to satisfy a power waste request. In other words, it is possible to prevent excessive waste of electric power regenerated by the electric motor 17, to prevent a decrease in SOC when regeneration has ended, and to prevent a situation of impossible regeneration (insufficient regenerative torque) due to full charging of the power storage device 16.

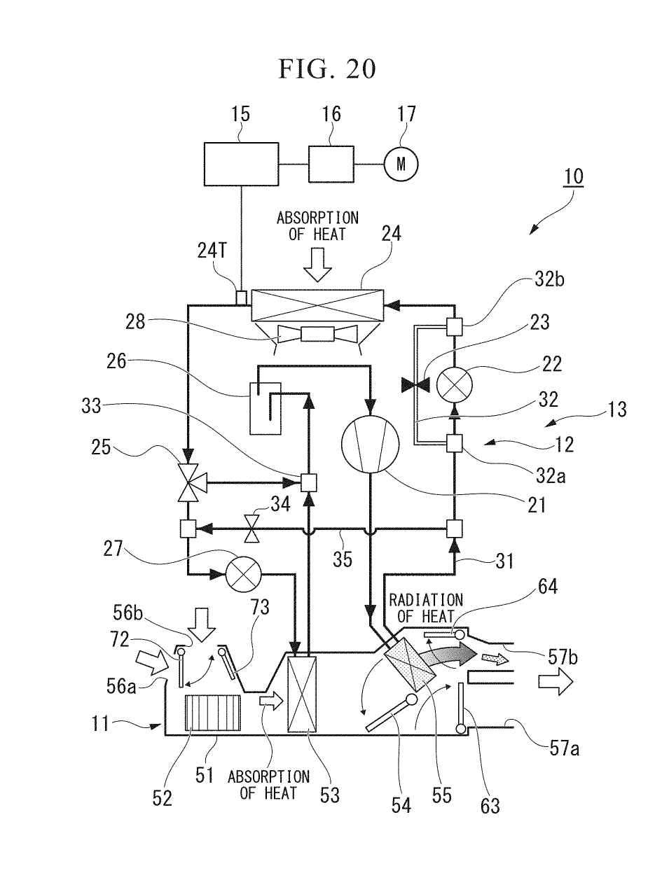

A dehumidifying and heating operation mode of the vehicular air conditioner 10 will be described now with reference to FIG. 20.

(Dehumidifying and Heating Operation Mode)

As illustrated in FIG. 20, when a heating operation is performed using the vehicular air conditioner 10, the first air guide unit 54 is located at the heating position at which conditioning air having passed through the second indoor heat exchanger 53 flows through a heating path and a dehumidifying electromagnetic valve 34 is in an open state. The cooling electromagnetic valve 23 is a closed state.

In this case, in the heat pump cycle 12, a high-temperature and high-pressure refrigerant discharged from the compressor 21 heats conditioning air in the duct 51 by radiation of heat in the indoor condenser 55. Some refrigerant of the refrigerant having passed through the indoor condenser 55 flows to the outdoor heat exchanger 24 and the other refrigerant flows into a dehumidifying flow passage 35.

Specifically, similarly to the heating operation, some refrigerant is expanded by the first expansion valve 22 and then absorbs heat from the vehicle exterior atmosphere in the outdoor heat exchanger 24.

The other refrigerant is guided to the second expansion valve 27 via the dehumidifying flow passage 35, is expanded by the second expansion valve 27, and then absorbs heat in the second indoor heat exchanger 53.

Some refrigerant and the other refrigerant merge in the merging portion 33 and flow into the gas-liquid separator 26, and only a gas-phase refrigerant flows into the compressor 21.

The conditioning air flowing in the duct 51 is cooled at the time of passing through the second indoor heat exchanger 53. At this time, the conditioning air passing through the second indoor heat exchanger 53 is cooled to a dew point or lower and thus is dehumidified. Thereafter, the dehumidified conditioning air passes through a heating path and is supplied to the vehicle interior via the air outlet 57b as dehumidifying and heating air.

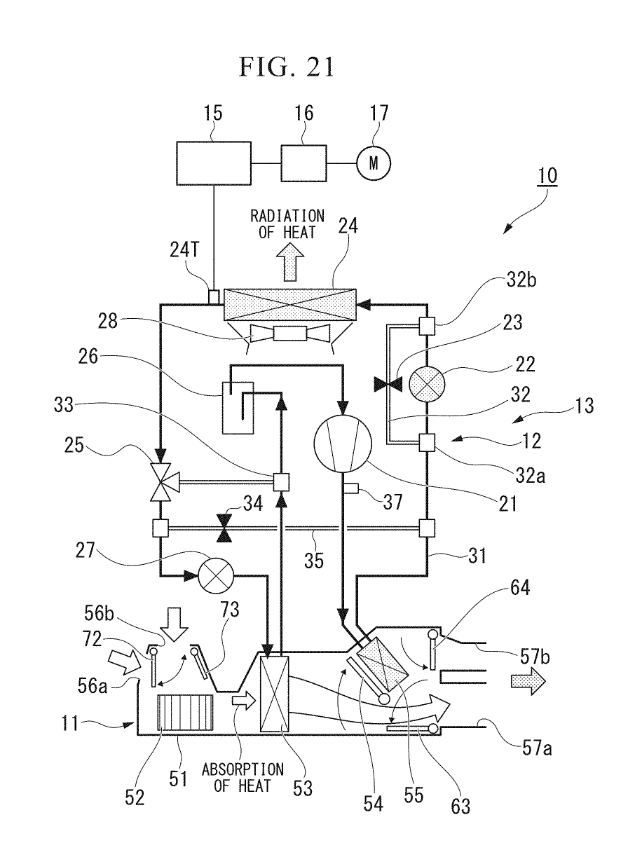

An example in which power waste control is performed such that the remaining capacity of the power storage device 16 is not greater than a predetermined value when regenerative power is stored in the power storage device 16 in the cooling operation mode, the dehumidifying and heating operation mode, and the like of the vehicular air conditioner 10 will be described now with reference to FIGS. 21 to 27 and Tables 1 and 2.

First, the power waste control of the vehicular air conditioner 10 in the cooling operation mode includes seventh to eleventh power waste controls. The seventh to eleventh power waste controls will be sequentially described below.

An example in which the power consumption of the vehicular air conditioner 10 is increased by performing control such that the cooling electromagnetic valve 23 of the vehicular air conditioner 10 is closed and the first expansion valve 22 is narrowed as the seventh power waste control will be described below with reference to FIG. 21.

(Seventh Power Waste Control)

As illustrated in FIG. 21, when the remaining capacity of the power storage device 16 is equal to or greater than a predetermined value, the controller 15 performs control such that the compressor 21 is operated, the cooling electromagnetic valve 23 is closed, and passage resistance of the first expansion valve 22 is greater than that when the remaining capacity of the power storage device 16 is less than the predetermined value.

In the seventh power waste control, when the remaining capacity of the power storage device 16 is equal to or greater than a predetermined value while operating the compressor 21, the passage resistance is increased by narrowing the first expansion valve 22. Accordingly, the passage resistance from the compressor 21 to the outdoor heat exchanger 24 is increased and a pressure loss (a friction loss) is increased in comparison with that before the power waste control has been performed, and thus it is possible to decrease an amount of refrigerant circulating in the refrigerant flow passage 31. That is, it is possible to decrease the efficiency of the cooling operation or the dehumidifying and cooling operation of the vehicular air conditioner 10.

In this state, in order to obtain the same cooling capability as before the power waste control has been performed, it is necessary to increase the rotation speed of the compressor 21 to increase the refrigerant flow rate. By increasing the rotation speed of the compressor 21, the power consumption of the compressor 21 can be increased and it is possible to secure an amount of waste power of the vehicular air conditioner 10.

Accordingly, in the seventh power waste control, when the power consumption of the compressor 21 is greater than electric power generated by the electric motor 17, it is possible to prevent overcharging of the power storage device 16. When the power consumption of the compressor 21 is less than electric power generated by the electric motor 17, it is possible to decrease a rate of increase of the remaining capacity of the power storage device 16.

Control of the compressor 21 is performed using information of a temperature sensor provided in the second indoor heat exchanger 53 or the like, for example, such that the temperature of the second indoor heat exchanger 53 reaches a target value.

The narrowing control of the first expansion valve 22 can be performed based on a necessary amount of waste power within an upper limit of the discharge pressure of the compressor 21. A target value of a discharge pressure sensor 37 is set depending on the necessary amount of waste power.

The work (the power consumption) of the compressor 21 increases with an increase in compression work, an increase in necessary flow rate of a refrigerant due to an increase in outlet enthalpy of the outdoor heat exchanger 24, an additional increase in rotation speed due to a decrease in volumetric efficiency, and the like. At this time, since the temperature of the indoor condenser 55 increases, the aperture of the first air guide unit 54 is decreased, for example, in order to cause a discharge air temperature (an amount of heat radiated) from the air outlet 57a to reach a target value. The increased work is mainly discharged as thermal energy from the outdoor heat exchanger 24. The aperture of the first air guide unit 54 in the dehumidifying and cooling operation is greater than that in the cooling operation and is an intermediate aperture between a fully closed state and a fully open state (not illustrated).

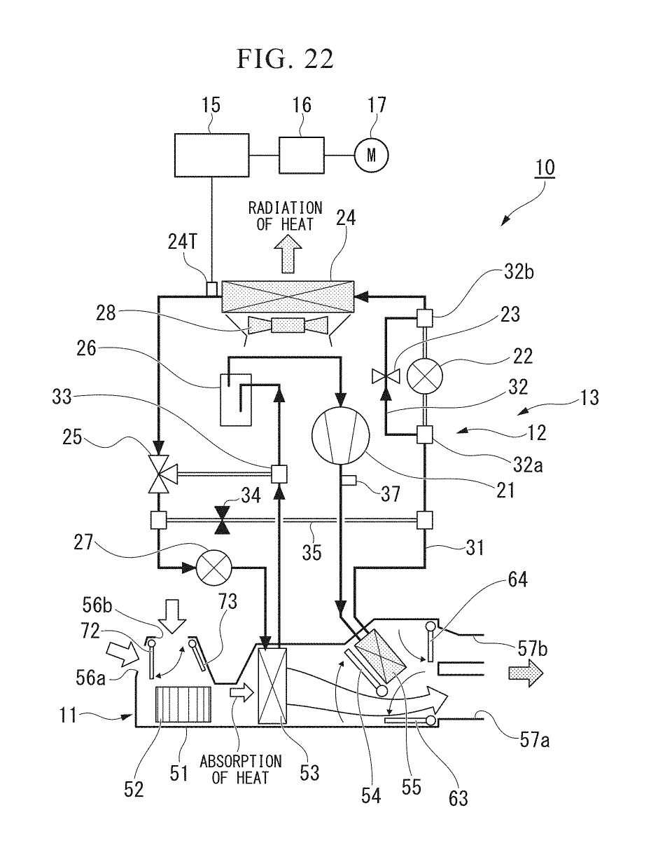

An example in which the power consumption of the vehicular air conditioner 10 is increased by opening the cooling electromagnetic valve 23 of the vehicular air conditioner 10 and controlling the second air guide unit 28 as the eighth power waste control will be described below with reference to FIG. 22.

(Eighth Power Waste Control)

As illustrated in FIG. 22, when the remaining capacity of the power storage device 16 is equal to or greater than a predetermined value, the controller 15 performs control such that the compressor 21 is operated and the cooling electromagnetic valve 23 is opened. Control is performed such that a passing-through air volume of the second air guide unit 28 that controls the passing-through air volume of the outdoor heat exchanger 24 is less than the passing-through air volume of the second air guide unit 28 when the remaining capacity of the power storage device 16 is less than the predetermined value.

That is, when the second air guide unit 28 is a condenser fan, the passing-through air volume of the second air guide unit 28 is decreased by decreasing the rotation speed of the fan or stopping the fan.

In this case, for example, the second air guide unit 28 can decelerate depending on a necessary amount of waste power within the upper limit of the discharge pressure of the compressor 21. The target value of the discharge pressure sensor 37 is set depending on the necessary amount of waste power.

When the second air guide unit 28 is a grille shutter, the passing-through air volume of the second air guide unit 28 is decreased by decreasing a gap of the grille shutter or closing the grille shutter.

When the grille shutter is closed, air resistance of a traveling vehicle decreases. Accordingly, even when an amount of waste power increases, the vehicle speed increases and thus there is concern that discomfort in brake feeling will occur.

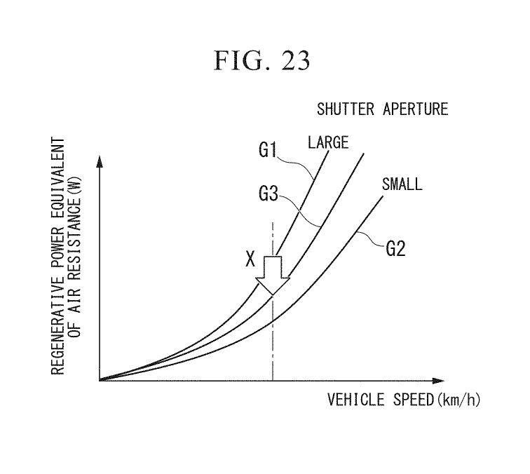

Therefore, in order to obtain the same vehicle deceleration feeling as before the grille shutter has been operated, the operation of the grille shutter is determined based on the following conditions. That is, when the following relationships are satisfied, a decrease in regenerative power X due to the operation of the grille shutter is calculated based on the characteristics of the graph illustrated in FIG. 23.

(Discharge pressure of discharge pressure sensor 37)<(upper-limited discharge pressure of compressor 21)

(wastable power by eighth power waste control)>(decrease in regenerative power due to operation of grille shutter)

In the graphs illustrated in FIG. 23, the vertical axis represents a regenerative power equivalent of air resistance (W). The “regenerative power equivalent of air resistance (W)” is regenerative power when the same resistive force equal to air resistance is given by regeneration. The horizontal axis represents a vehicle speed (km/h). Graphs G1 to G3 indicate magnitudes of the aperture of the grille shutter.

By decreasing the passing-through air volume of the second air guide unit 28, the passing-through air volume of the outdoor heat exchanger 24 can be decreased and the amount of heat radiated from the outdoor heat exchanger 24 can be decreased.

A refrigerant having passed through the cooling electromagnetic valve 23 flows in a high-temperature and a high-pressure state into the outdoor heat exchanger 24. Accordingly, by decreasing the amount of heat radiated from the outdoor heat exchanger 24, the temperature and the pressure of the refrigerant increase. Accordingly, it is possible to decrease an efficiency of the cooling operation or the dehumidifying and cooling operation of the vehicular air conditioner 10.

In this state, in order to obtain the same cooling capability as before the power waste control has been performed, it is necessary to increase the rotation speed of the compressor 21 to increase the refrigerant flow rate. By increasing the rotation speed of the compressor 21, the power consumption of the compressor 21 can be increased and it is possible to secure an amount of waste power of the vehicular air conditioner 10.

Accordingly, in the eighth power waste control, when the power consumption of the compressor 21 is greater than electric power generated by the electric motor 17, it is possible to prevent overcharging of the power storage device 16. When the power consumption of the compressor 21 is less than electric power generated by the electric motor 17, it is possible to decrease a rate of increase of the remaining capacity of the power storage device 16.

Control of the compressor 21 is performed using information of a temperature sensor provided in the second indoor heat exchanger 53 or the like, for example, such that the temperature of the second indoor heat exchanger 53 reaches a target value.

The work (the power consumption) of the compressor 21 increases with an increase in compression work, an increase in necessary flow rate of a refrigerant due to an increase in outlet enthalpy of the outdoor heat exchanger 24, an additional increase in rotation speed due to a decrease in volumetric efficiency, and the like. At this time, since the temperature of the indoor condenser 55 increases, the aperture of the first air guide unit 54 is decreased, for example, in order to cause a discharge air temperature (an amount of heat radiated) from the air outlet 57a to reach a target value. The increased work is mainly discharged as thermal energy from the outdoor heat exchanger 24. The aperture of the first air guide unit 54 in the dehumidifying and cooling operation is greater than that in the cooling operation and is an intermediate aperture between a fully closed state and a fully open state (not illustrated).

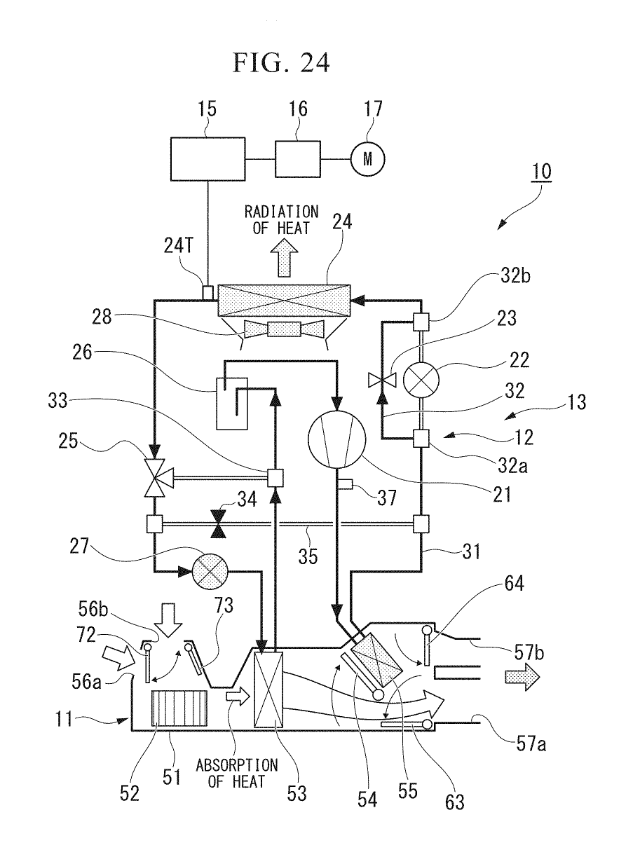

An example in which the power consumption of the vehicular air conditioner 10 is increased by performing control such that the cooling electromagnetic valve 23 of the vehicular air conditioner 10 is opened and the aperture of the second expansion valve 27 is decreased as the ninth power waste control will be described below with reference to FIG. 24.

(Ninth Power Waste Control)

As illustrated in FIG. 24, when the remaining capacity of the power storage device 16 is equal to or greater than a predetermined value, the controller 15 performs control such that the compressor 21 is operated and the second expansion valve 27 is narrowed. By narrowing the second expansion valve 27, the aperture of the second expansion valve 27 becomes less than that when the remaining capacity of the power storage device 16 is less than a predetermined value.

In the ninth power waste control, when the remaining capacity of the power storage device 16 is equal to or greater than a predetermined value while operating the compressor 21, the aperture of the second expansion valve 27 is decreased. Accordingly, it is possible to decrease an amount of refrigerant circulating in the refrigerant flow passage 31 from the compressor 21 to the outdoor heat exchanger 24 in comparison with before the power waste control has been performed. That is, it is possible to decrease the efficiency of the cooling operation or the dehumidifying and cooling operation of the vehicular air conditioner 10.

In this state, in order to obtain the same cooling capability as before the power waste control has been performed, it is necessary to increase the rotation speed of the compressor 21 to increase the refrigerant flow rate. By increasing the rotation speed of the compressor 21, the power consumption of the compressor 21 can be increased and it is possible to secure an amount of waste power of the vehicular air conditioner 10.

Accordingly, in the ninth power waste control, when the power consumption of the compressor 21 is greater than electric power generated by the electric motor 17, it is possible to prevent overcharging of the power storage device 16. When the power consumption of the compressor 21 is less than electric power generated by the electric motor 17, it is possible to decrease a rate of increase of the remaining capacity of the power storage device 16.

Control of the compressor 21 is performed using information of a temperature sensor provided in the second indoor heat exchanger 53 or the like, for example, such that the temperature of the second indoor heat exchanger 53 reaches a target value.

The aperture of the second expansion valve 27 can be decreased based on a necessary amount of waste power within an upper limit of the discharge pressure of the compressor 21. A target value of a discharge pressure sensor 37 is set depending on the necessary amount of waste power.

The work (the power consumption) of the compressor 21 increases with an increase in compression work, an increase in necessary flow rate of a refrigerant due to an increase in outlet enthalpy of the outdoor heat exchanger 24, an additional increase in rotation speed due to a decrease in volumetric efficiency, and the like. At this time, since the temperature of the indoor condenser 55 increases, the aperture of the first air guide unit 54 is decreased, for example, in order to cause a discharge air temperature (an amount of heat radiated) from the air outlet 57a to reach a target value. The increased work is mainly discharged as thermal energy from the outdoor heat exchanger 24. The aperture of the first air guide unit 54 in the dehumidifying and cooling operation is greater than that in the cooling operation and is an intermediate aperture between a fully closed state and a fully open state (not illustrated).

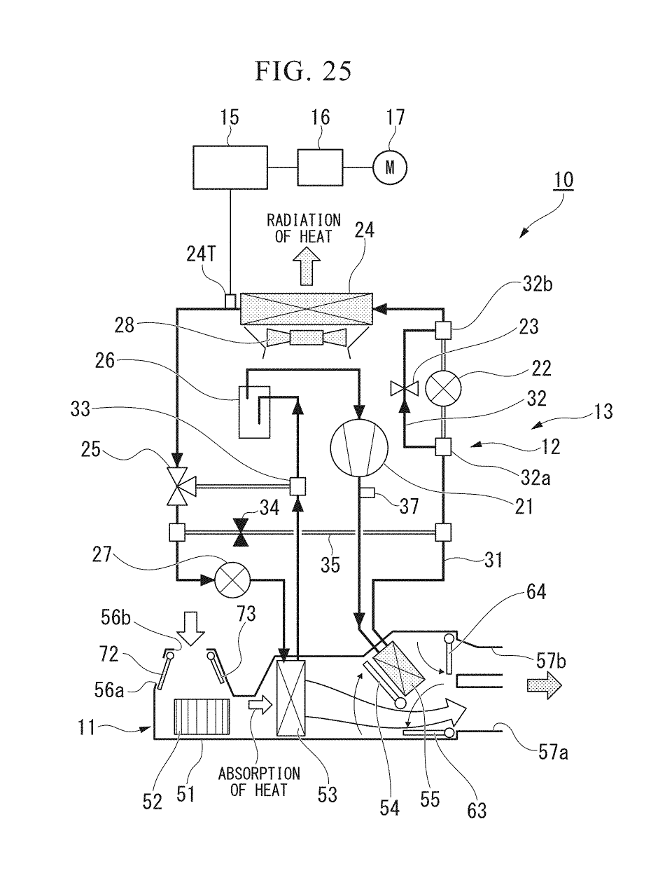

An example in which the power consumption of the vehicular air conditioner 10 is increased by performing control such that a switching unit 59 of the vehicular air conditioner 10 is switched to introduce the vehicle exterior air as the tenth power waste control will be described below with reference to FIG. 25.

(Tenth Power Waste Control)

As illustrated in FIG. 25, when the remaining capacity of the power storage device 16 is equal to or greater than a predetermined value, the controller 15 performs control such that the switching unit 59 is switched to introduce the vehicle exterior air.

For example, the indoor air inlet 56a is switched to the closed state by the indoor air door 72 of the switching unit 59 and the outdoor air inlet 56b is switched to the open state by the outdoor air door 73. Accordingly, high-temperature air of the vehicle exterior (that is, outdoor air) 75 can be introduced into the duct 51 via the outdoor air inlet 56b. By introducing high-temperature outdoor air 75 into the duct 51, it is possible to decrease the operation efficiency of the vehicular air conditioner 10.

In this state, in order to obtain the same cooling capability as before the power waste control has been performed, it is possible to increase the cooling work of the vehicular air conditioner 10 to increase the power consumption thereof.

Accordingly, in the tenth power waste control, when the power consumption of the compressor 21 is greater than electric power generated by the electric motor 17, it is possible to prevent overcharging of the power storage device 16. When the power consumption of the compressor 21 is less than electric power generated by the electric motor 17, it is possible to decrease a rate of increase of the remaining capacity of the power storage device 16.

The tenth power waste control may be the dehumidifying and cooling operation as well as the cooling operation. In the dehumidifying and cooling operation, the aperture of the first air guide unit 54 is greater than that in the cooling operation and is an intermediate aperture between a fully closed state and a fully open state (not illustrated).

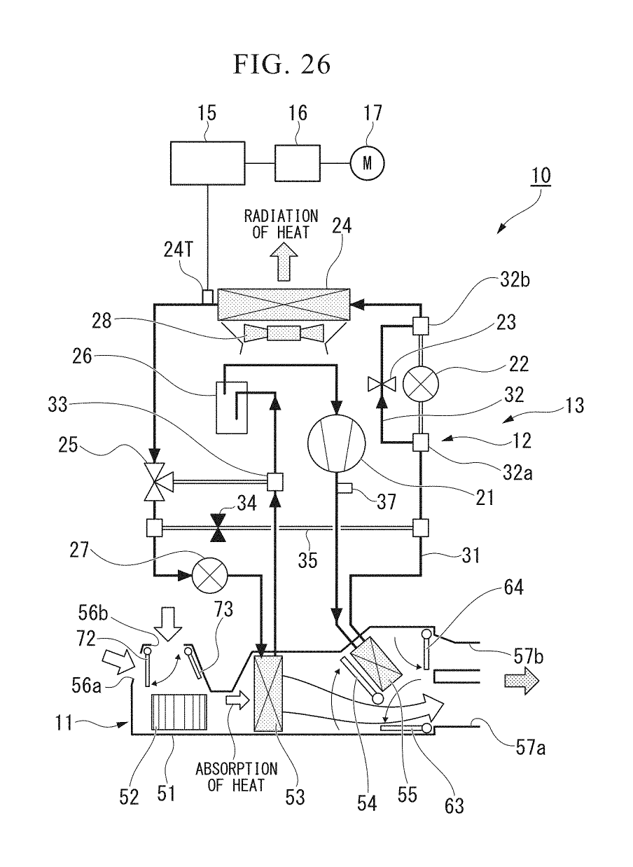

An example in which the power consumption of the vehicular air conditioner 10 is increased by performing control such that a target temperature of the second indoor heat exchanger 53 of the vehicular air conditioner 10 is decreased and a target temperature of the indoor condenser 55 is increased as the eleventh power waste control will be described below with reference to FIG. 26.

(Eleventh Power Waste Control)

As illustrated in FIG. 26, when the remaining capacity of the power storage device 16 is equal to or greater than a predetermined value, the controller 15 performs control such that the compressor 21 is operated and the target temperature of the second indoor heat exchanger 53 is lower than the target temperature of the second indoor heat exchanger 53 when the remaining capacity of the power storage device 16 is less than a predetermined value. At the same time, the controller 15 performs control such that the target temperature of the indoor condenser 55 is higher than the target temperature of the indoor condenser 55 when the remaining capacity of the power storage device 16 is less than the predetermined value.

In this way, by decreasing the target temperature of the second indoor heat exchanger 53, it is possible to increase the cooling work of the vehicular air conditioner 10. By increasing the target temperature of the indoor condenser 55, it is possible to increase the heating work of the vehicular air conditioner 10. Accordingly, it is possible to decrease the operation efficiency of the vehicular air conditioner 10 and to increase the power consumption.

By decreasing the temperature of air using the second indoor heat exchanger 53 and reheating the air with the temperature decreased using the indoor condenser 55, it is possible to obtain the same cooling capability as before the power waste control has been performed.

In the state in which the same cooling capability as before the power waste control has been performed has been acquired, it is possible to increase the power consumption of the vehicular air conditioner 10. Accordingly, in the eleventh power waste control, when the power consumption of the compressor 21 is greater than electric power generated by the electric motor 17, it is possible to prevent overcharging of the power storage device 16. When the power consumption of the compressor 21 is less than electric power generated by the electric motor 17, it is possible to decrease a rate of increase of the remaining capacity of the power storage device 16.

The eleventh power waste control may be the dehumidifying and cooling operation as well as the cooling operation. In the dehumidifying and cooling operation, the aperture of the first air guide unit 54 is greater than that in the cooling operation and is an intermediate aperture between a fully closed state and a fully open state (not illustrated).

For example, when a degree of heating in the indoor condenser 55 is excessively large, the first air guide unit 54 is moved into the closed state and it is thus possible to obtain the same cooling capability as before the power waste control has been performed.

On the other hand, when a degree of cooling in the second indoor heat exchanger 53 is excessively large, the first air guide unit 54 is moved into the open state and it is thus possible to obtain the same cooling capability as before the power waste control has been performed.

By adjusting a decrease in temperature of the second indoor heat exchanger 53, it is possible to adjust an increase in power consumption.

When the dehumidifying and heating operation illustrated in FIG. 20 or the heating operation illustrated in FIG. 2 is being performed and a target discharge air temperature is equal to or less than a predetermined value, the operation mode can be switched to the dehumidifying and heating operation in the seventh to eleventh power waste controls. By setting the predetermined value for the discharge air temperature by the outdoor air temperature and the blower voltage, it is possible to improve accuracy and to switch the operation mode in a wider target discharge air temperature range.

The power waste control of the vehicular air conditioner 10 in the dehumidifying and heating operation mode will be described below. When the power waste control is performed in the dehumidifying and heating operation mode illustrated in FIG. 20, the operation is switched to the cooling operation mode and the seventh to eleventh power waste controls illustrated in FIGS. 21 to 26 which have been described in the cooling operation mode are performed.

In this way, by performing the power waste control in the cooling operation mode, the dehumidifying operation (dehumidifying and cooling operation and dehumidifying and heating operation) mode, and the like, the efficiency of a cooling cycle using the vehicular air conditioner 10 is decreased and the power consumption of the vehicular air conditioner 10 is increased. Accordingly, when the power consumption of the compressor 21 is greater than electric power generated by the electric motor 17, it is possible to prevent overcharging of the power storage device 16. When the power consumption of the compressor 21 is less than electric power generated by the electric motor 17, it is possible to decrease a rate of increase of the remaining capacity of the power storage device 16.

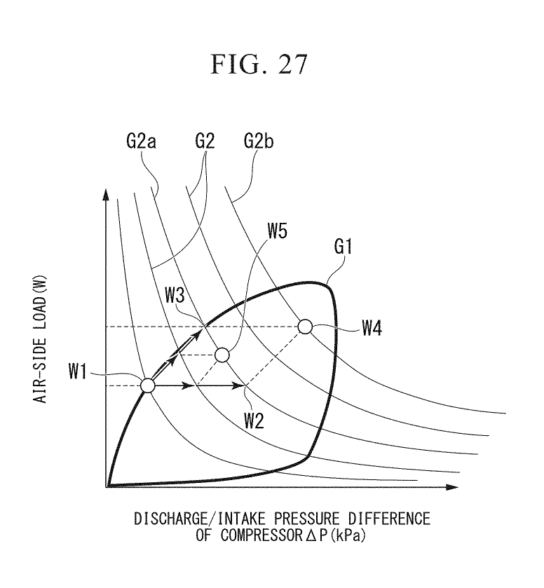

An example in which the seventh to eleventh power waste controls are performed in combination depending on an increase in the power consumption (an amount of waste power) which is required for prevention of overcharging of the power storage device 16 will be described below with reference to FIG. 27 and Tables 1 and 2.

FIG. 27 illustrates a relationship of the power consumption with respect to an intake/discharge pressure difference of the compressor 21 and an air-side load (an air-conditioning load). In FIG. 27, the vertical axis represents an air-side load (W) and the horizontal axis represents an intake/discharge pressure difference ΔP (kPa) of the compressor 21. A cooling operation range is indicated by a diagram G1 and the power consumption is indicated by an isoelectric power curve G2.

In the isoelectric power curve G2, an isoelectric power curve G2a indicates target power consumption (that is, a target amount of waste power) and an isoelectric power curve G2b indicates maximum power consumption (that is, a maximum amount of waste power).

By ascertaining characteristics of the diagrams illustrated in FIG. 27, the seventh to eleventh power waste controls can be appropriately combined depending on an increase in power consumption (an amount of waste power) which is required for prevention of overcharging of the power storage device 16. It is preferable that the seventh to eleventh power waste controls be combined in consideration of control performance of an amount of waste power in the seventh to eleventh power waste controls.

When the power consumption appearing in the diagrams illustrated in FIG. 27 is set for each of an evaporation temperature of the second indoor heat exchanger 53, a discharge pressure of the compressor 21, and an intake pressure of the compressor 21, the accuracy for combining the seventh to eleventh power waste controls is further improved.

When there are a plurality of combinations of the seventh to eleventh power waste controls, it is preferable that one combination be selected with priorities of the power waste controls determined based on constraint conditions such as first to fifth conditions.

The first condition is power waste control in which responsiveness when power consumption is increased has priority.

The second condition is power waste control in which an influence on durability has priority.

The third condition is power waste control in which an influence on noise/vibration (NV) has priority.

The fourth condition is power waste control in which AC temperature change has priority.

The fifth condition is power waste control in which AC discomfort has priority.

The “AC temperature change” refers to change in the discharge air temperature or fluctuation including continuous change. The “AC discomfort” refers to smell resulting from the vehicular air conditioner 10, a difference in discharge air temperature between an inlet and an outlet, change or fluctuation in air volume, and the like other than the temperature change.

The priorities of the first to fifth conditions are set, for example, as follows.

That is, regarding the priorities of the first to fifth conditions, which condition is satisfied is determined from time to time. Particularly, when no preferred condition has been satisfied or a plurality of preferred conditions have been satisfied, determination is based on the priorities “A to E” which are preset in Table 1.

The “preferred conditions” are described in Table 1.

TABLE 1

| Require- | | |
|---|---|---|
| ment | | |
| and | | |
| constraint | | |
| condition | Preferred condition | Priority |
| First | Which is determined depending on an SOC | A |
| condition | level, a vehicle speed, a gradient, a brake | |
| (responsive- | depressing force, a turning angle of a steering | |
| ness) | wheel, and the like when start and stop of | |
| | power waste or adjustment of an amount of | |
| | waste power more than predetermined | |
| | responsiveness is required depending on a | |
| | traveling state | |
| Second | When a total operation time or total work of a | B |
| condition | compressor is greater than a predetermined | |
| (influence | value due to heavy use thereof and priority is | |
| on | given to prevention of functional loss due to | |
| durability) | malfunction within a predetermined traveling | |
| | distance or used time more than performance | |
| | due to power waste | |
| Third | When a vehicle speed is low or a vehicle stops | C |
| condition | but a battery SOC is decreased by power | |
| (influence | waste in preparation for a downhill | |
| of NV) | | |
| Fourth | When a difference between a room temperature | D |
| condition | and a target room temperature is great and | |
| (AC | insufficiency for a target discharge air temperature | |
| temperature | is minimized or when a difference between a | |
| change) | room temperature and a target room temperature | |
| | is small and change in discharge air temperature | |
| | is remarkable | |
| Fifth | When outdoor air humidity is high and change | E |
| condition | in humidity or smell of discharge air is great | |
| (AC | depending on when dehumidification is performed | |
| discomfort) | or when a difference in discharge air temperature | |
| | due to dehumidification changes at two or more | |
| | outlets | |

That is, when it is intended to rapidly increase power consumption at the time of prevention of overcharging of the power storage device 16, the power waste control of the first condition is selected in consideration of the “preferred conditions” in Table 1. When it is intended to curb an influence on durability of the vehicular air conditioner 10 at the time of prevention of overcharging of the power storage device 16, the power waste control of the second condition is selected in consideration of the “preferred conditions” in Table 1. When it is intended to curb an influence of noise/vibration (hereinafter referred to as NV) on the vehicular air conditioner 10 (that is, the motor-driven vehicle Ve) at the time of prevention of overcharging of the power storage device 16, the power waste control of the third condition is selected in consideration of the “preferred conditions” in Table 1.

When it is intended to prevent an influence of temperature change on cooling and dehumidification of the vehicular air conditioner 10 at the time of prevention of overcharging of the power storage device 16, the power waste control of the fourth condition is selected in consideration of the “preferred conditions” in Table 1. When it is intended to prevent an influence of discomfort on cooling and dehumidification of the vehicular air conditioner 10 at the time of prevention of overcharging of the power storage device 16, the power waste control of the fifth condition is selected in consideration of the “preferred conditions” in Table 1.

Selection of the seventh to eleventh power waste controls includes combinations of the power waste controls and is preferably performed based on a necessary amount of waste power depending on power consumption characteristics with respect to the intake/discharge pressure difference of the compressor 21 and an air-side load (an air-conditioning load) which appear in the diagram illustrated in FIG. 27.

For example, by performing the seventh to ninth power waste controls out of the seventh to eleventh power waste controls, the power consumption W2 after the power waste control has been performed can be increased from the power consumption W1 before the power waste control has been performed to the target amount of waste power. By performing the tenth and eleventh power waste controls, the power consumption W3 after the power waste control has been performed can be increased from the power consumption W1 before the power waste control has been performed to the target amount of waste power.

In addition, by performing the seventh to eleventh power waste controls, the power consumption W4 after the power waste control has been performed can be increased from the power consumption W1 before the power waste control has been performed to the maximum amount of waste power.

By performing the power waste control selected from the seventh to eleventh power waste controls and performing the power waste control selected out of the tenth and eleventh power waste controls, the power consumption W5 after the power waste control has been performed can be increased from the power consumption W1 before the power waste control has been performed to the target amount of waste power.

An example in which preferable power waste control is selected out of the seventh to eleventh power waste controls such that the first to fifth conditions are satisfied will be described below with reference to Table 2. As performance levels for selecting power waste control, “Aa” to “Ae,” “Ba” to “Be,” “Ca” to “Ce,” “Da” to “De,” and “Ea” to “Ee” are described in Table 2.

The order of “Aa” to “Ae,” “Ba” to “Be,” “Ca” to “Ce,” “Da” to “De,” and “Ea” to “Ee” described in Table 2 varies depending on specifications of a vehicle. For example, when the first condition has been satisfied, the power waste controls in the first condition are sequentially performed from one having the lowest power consumption.

For example, when the power consumption satisfies Aa<Ab<Ac<Ad<Ae, the power waste controls are sequentially performed from “Aa” having the lowest power consumption.

The power waste control which can be performed varies depending on a situation such as a vehicle. For example, it is conceivable that the power waste control of “Ac” and “Ae” cannot be performed even when the power consumption when the power waste control has been performed under the first condition satisfies Aa<Ab<Ac<Ad<Ae. In this case, the power waste controls of “Aa,” “Ab,” and “Ad” are sequentially selected and performed from the power waste control having the lowest power consumption.

The priorities for selecting preferable power waste control out of the seventh to eleventh power waste controls to satisfy the first to fifth conditions will be described below with reference to Table 2.

TABLE 2

| | | Seventh | Eighth | Ninth | Tenth | Eleventh |
|---|---|---|---|---|---|---|
| | | power | power | power | power | power |
| Requirement and constraint | | waste | waste | waste | waste | waste |
| condition | | control | control | control | control | control |
| First condition | Good = fast | Aa | Ab | Ac | Ad | Ae |
| (responsiveness) | | | | | | |
| Second | Good = little | Ba | Bb | Bc | Bd | B |
| condition | influence | | | | | |
| (influence on | | | | | | |
| durability) | | | | | | |
| Third condition | Good = little | Ca | Cb | Cc | Cd | Ce |
| (influence of | influence | | | | | |
| NV) | | | | | | |
| Fourth | Good = little | Da | Db | Dc | Dd | De |
| condition (AC | change | | | | | |
| temperature | | | | | | |
| change) | | | | | | |
| Fifth condition | Good = little | Ea | Eb | Ec | Ed | Ee |
| (AC discomfort) | discomfort | | | | | |

First, an example in which the power waste control is performed in consideration of the first condition will be described with reference to Table 2.

For example, in a case in which the power consumption at the performance level of the first condition satisfies Aa<Ab<Ac<Ad<Ae and the power waste controls of “Aa” to “Ae” can be performed, the seventh power waste control of “Aa” is selected when it is intended to secure the power consumption having most excellent responsiveness. The eighth power waste control of “Ab” is selected when it is intended to secure the power consumption having next excellent responsiveness following the seventh power waste control. The ninth power waste control of “Ac” is selected when it is intended to secure the power consumption having next excellent responsiveness following the eighth power waste control. The tenth power waste control of “Ad” is selected when it is intended to secure the power consumption having next excellent responsiveness following the ninth power waste control. The eleventh power waste control of “Ae” is selected when it is intended to secure the power consumption having next excellent responsiveness following the tenth power waste control.

An example in which the power waste control is performed in consideration of the second condition will be described below. For example, in a case in which the power consumption at the performance level of the second condition satisfies Ba<Bb<Bc<Bd<Be and the power waste controls of “Ba” to “Be” can be performed, the seventh power waste control of “Ba” is selected when it is most intended to decrease an influence on durability. The eighth power waste control of “Bb” is selected when it is intended to decrease an influence on durability following the seventh power waste control. The ninth power waste control of “Bc” is selected when it is intended to decrease an influence on durability following the eighth power waste control. The tenth power waste control of “Bd” is selected when it is intended to decrease an influence on durability following the ninth power waste control. The eleventh power waste control of “Be” is selected when it is intended to decrease an influence on durability following the tenth power waste control.

An example in which the power waste control is performed in consideration of the third condition will be described below. For example, in a case in which the power consumption at the performance level of the third condition satisfies Ca<Cb<Cc<Cd<Ce and the power waste controls of “Ca” to “Ce” can be performed, the seventh power waste control of “Ca” is selected when it is most intended to decrease an influence on NV. The eighth power waste control of “Cb” is selected when it is intended to decrease an influence on NV following the seventh power waste control. The ninth power waste control of “Cc” is selected when it is intended to decrease an influence on NV following the eighth power waste control. The tenth power waste control of “Cd” is selected when it is intended to decrease an influence on NV following the ninth power waste control. The eleventh power waste control of “Ce” is selected when it is intended to decrease an influence on NV following the tenth power waste control.

An example in which the power waste control is performed in consideration of the fourth condition will be described below. For example, in a case in which the power consumption at the performance level of the fourth condition satisfies Da<Db<Dc<Dd<De and the power waste controls of “Da” to “De” can be performed, the seventh power waste control of “Da” is selected when it is most intended to decrease temperature change. The eighth power waste control of “Db” is selected when it is intended to decrease temperature change following the seventh power waste control. The ninth power waste control of “Dc” is selected when it is intended to decrease temperature change following the eighth power waste control. The tenth power waste control of “Dd” is selected when it is intended to decrease temperature change following the ninth power waste control.

The eleventh power waste control of “De” is selected when it is intended to decrease temperature change following the tenth power waste control.

An example in which the power waste control is performed in consideration of the fifth condition will be described below. For example, in a case in which the power consumption at the performance level of the fifth condition satisfies Ea<Eb<Ec<Ed<Ee and the power waste controls of “Ea” to “Ee” can be performed, the seventh power waste control of “Ea” is selected when it is most intended to decrease discomfort. The eighth power waste control of “Eb” is selected when it is intended to decrease discomfort following the seventh power waste control. The ninth power waste control of “Ec” is selected when it is intended to decrease discomfort following the eighth power waste control.

The tenth power waste control of “Ed” is selected when it is intended to decrease discomfort following the ninth power waste control. The eleventh power waste control of “Ee” is selected when it is intended to decrease discomfort following the tenth power waste control.

In this way, by selecting the seventh to eleventh power waste controls in consideration of the first to fifth conditions described in Table 2, the power waste controls satisfying the conditions can be performed.

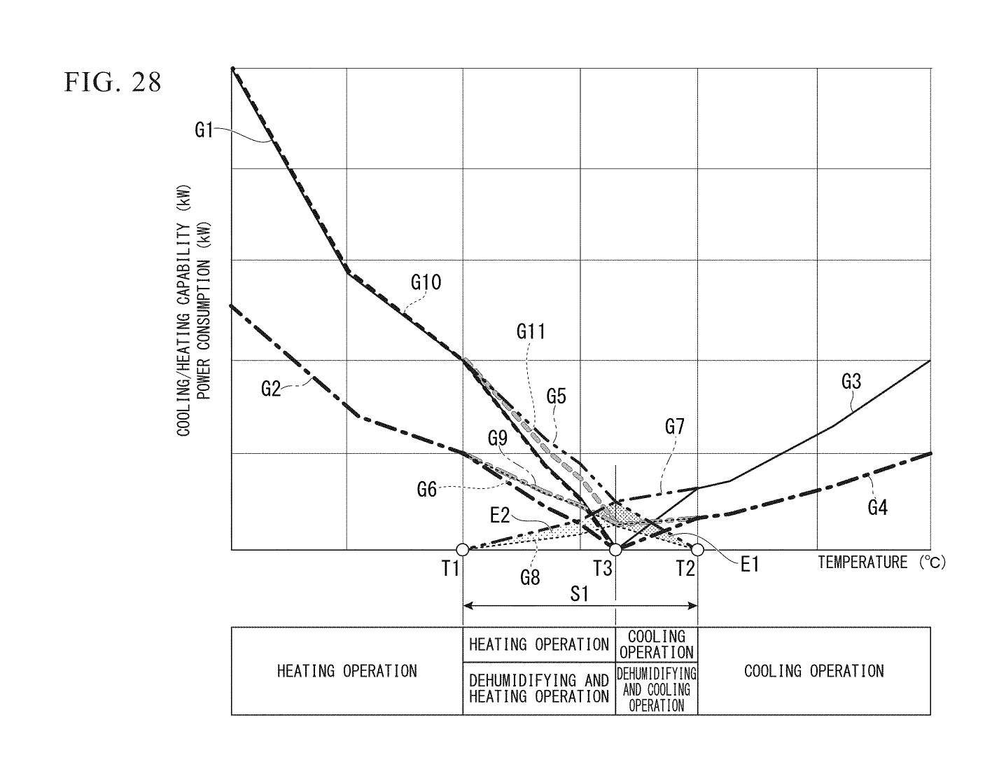

An example in which power waste of the vehicular air conditioner 10 is controlled by switching the operation mode between a first operation and a second operation with a predetermined temperature of the vehicular air conditioner 10 as a threshold when the remaining capacity of the power storage device 16 is equal to or greater than a predetermined value will be described below with reference to FIGS. 1 and 28.

FIG. 28 is a diagram illustrating a control state in which the vehicular air conditioner 10 is switched to a first operation and a second operation at a predetermined temperature T3. In FIG. 28, the vertical axis represents power consumption and an air-conditioning capability of the vehicular air conditioner 10 and the horizontal axis represents the temperature of the vehicular air conditioner 10.

Graph G1 indicates a heating capability of the vehicular air conditioner 10. Graph G2 indicates heating power consumption in the heating operation of the vehicular air conditioner 10 before power waste control has been performed. In FIG. 28, a heating coefficient of performance (COP) which is obtained by dividing the heating capability by the heating power consumption is referred to as, for example, heating COP=2.

Graph G3 indicates a cooling capability of the vehicular air conditioner 10. Graph G4 indicates cooling power consumption in the cooling operation of the vehicular air conditioner 10 before power waste control has been performed. In FIG. 28, a cooling COP which is obtained by dividing the cooling capability by the cooling power consumption is referred to as, for example, cooling COP=2.

Here, the predetermined temperature T3 includes a first predetermined temperature T1 and a second predetermined temperature T2. The second predetermined temperature T2 is a temperature higher than the first predetermined temperature T1. In other words, the first predetermined temperature T1 and the second predetermined temperature T2 are included in the predetermined temperature T3. A temperature difference between the first predetermined temperature T1 and the second predetermined temperature T2 is S1.

The temperature difference S1 between the first predetermined temperature T1 and the second predetermined temperature T2 is controlled by the controller 15 such that the temperature difference when the remaining capacity of the power storage device 16 is equal to or greater than the predetermined value is greater than when the remaining capacity of the power storage device 16 is less than the predetermined value.

The temperature difference S1 is secured by the first predetermined temperature T1 and the second predetermined temperature T2. Between the first predetermined temperature T1 and the second predetermined temperature T2, the heating capability of the vehicular air conditioner 10 is indicated by Graph G5 and the heating power consumption of the vehicular air conditioner 10 is indicated by Graph G6. The cooling capacity is indicated by Graph G7 and the cooling power consumption is indicated by Graph G8.

In the range between the first predetermined temperature T1 and the second predetermined temperature T2, the total power consumption of the heating power consumption and the cooling power consumption of the vehicular air conditioner 10 is indicated by Graph G9.

An area E1 indicates an amount of waste power of the vehicular air conditioner 10 which is acquired by decreasing a heating efficiency using the first to sixth power waste controls illustrated in FIGS. 4 to 19. An area E2 indicates an amount of waste power which is acquired by decreasing a cooling efficiency using the seventh to eleventh power waste controls illustrated in FIGS. 21 to 26.

Graph G10 indicates the heating power consumption of the heat-radiating unit 58 of the first indoor heat exchanger 61. Graph G11 indicates the total power consumption of the heating power consumption and the cooling power consumption of the heat-radiating unit 58.

The vehicular air conditioner 10 performs a heating operation at a temperature which is lower than the first predetermined temperature T1 and performs a cooling operation at a temperature which is equal to or higher than the second predetermined temperature T2. The vehicular air conditioner 10 can perform the heating operation and the cooling operation together in the range between the first predetermined temperature T1 and the second predetermined temperature T2. Alternatively, in the range between the first predetermined temperature T1 and the second predetermined temperature T2, the vehicular air conditioner 10 can perform the dehumidifying and heating operation and the dehumidifying and cooling operation together.

Examples of the first predetermined temperature T1 and the second predetermined temperature T2 include T1=0° C. and T2=30° C. when the remaining capacity of the power storage device 16 is equal to or greater than a predetermined value, and other temperatures may be set.

An example in which power waste control of the vehicular air conditioner 10 is performed in a state in which the first predetermined temperature T1 and the second predetermined temperature T2 are included in the predetermined temperature (the vehicle interior temperature) T3 which is requested by a user of the motor-driven vehicle Ve will be described below with reference to FIGS. 1 and 28.

First, an example in which the power waste control is performed when the predetermined temperature T3 which is requested by a user of the motor-driven vehicle Ve is equal to or greater than the first predetermined temperature T1 and less than the second predetermined temperature T2 in a state in which the vehicular air conditioner 10 operates will be described.

As illustrated in FIGS. 1 and 28, the controller 15 performs control such that the operation mode is switched between the cooling operation (that is, the first operation) and the heating operation (that is, the second operation) with the predetermined temperature T3 as a threshold when the remaining capacity of the power storage device 16 is equal to or greater than a predetermined value in a state in which the vehicular air conditioner 10 operates.

The predetermined temperature T3 refers to a temperature which is set within the range between the first predetermined temperature T1 and the second predetermined temperature T2 and at which the magnitude relationship of the power consumption changes in the power waste control using the cooling operation and the power waste control using the heating operation. The predetermined temperature T3 is, for example, a vehicle interior temperature which is requested by a user of the motor-driven vehicle Ve. For example, when the remaining capacity of the power storage device 16 is equal to or greater than a predetermined value, 20° C. can be used as the predetermined temperature T3, and another temperature may be set depending on an environment temperature such as an outdoor air temperature.

In the embodiment, the predetermined temperature T3 is set to a vehicle interior temperature which is requested by a user, but is not limited thereto. For example, the predetermined temperature T3 may be set to an outdoor air temperature or a vehicle interior temperature (which does not include a request from a user).

In this state, the operation mode is switched between the first operation and the second operation by switching a ratio of a decrease in pressure by the second expansion valve 27 to a decrease in pressure by the first expansion valve 22.

For example, in a cooling operation, the switching is performed such that the decrease in pressure by the second expansion valve 27 illustrated in FIG. 1 becomes greater than the decrease in pressure by the first expansion valve 22. This switching state includes a state in which the first expansion valve 22 is switched to a state in which a refrigerant is not decompressed and the second expansion valve 27 is switched to decompress the refrigerant. Alternatively, the switching state includes a state in which the first expansion valve 22 is switched to slightly decompress the refrigerant and the second expansion valve 27 is switched to decompress the refrigerant.

In a heating operation, the switching is performed such that the decrease in pressure by the first expansion valve 22 illustrated in FIG. 1 becomes greater than the decrease in pressure by the second expansion valve 27. This switching state includes a state in which the second expansion valve 27 is switched to a state in which a refrigerant is not decompressed and the first expansion valve 22 is switched to decompress the refrigerant. Alternatively, the switching state includes a state in which the second expansion valve 27 is switched to slightly decompress the refrigerant and the first expansion valve 22 is switched to decompress the refrigerant.

The state in which the ratio of the decrease in pressure by the second expansion valve 27 to the decrease in pressure by the first expansion valve 22 is switched includes a case in which the operation state has changed without change in the magnitude relationship between the decrease in pressure by the first expansion valve 22 and the decrease in pressure by the second expansion valve 27.

For example, by switching a heating operation to a cooling operation with the predetermined temperature T3 as a threshold, it is possible to decrease a heating efficiency. Accordingly, in the heating operation, the power consumption of the vehicular air conditioner 10 (see Graph G9) can be increased to obtain the same heating capability as before the power waste control has been performed (see Graph G5).

On the other hand, for example, by switching a cooling operation to a heating operation with the predetermined temperature T3 as a threshold, it is possible to decrease a cooling efficiency. Accordingly, in the cooling operation, the power consumption of the vehicular air conditioner 10 (see Graph G9) can be increased to obtain the same cooling capability as before the power waste control has been performed (see Graph G7).

When the power consumption of the vehicular air conditioner 10 is greater than electric power generated by the electric motor 17 in a state in which the power consumption of the vehicular air conditioner 10 (see Graph G9) has been increased in this way, it is possible to prevent overcharging of the power storage device 16. When the power consumption of the vehicular air conditioner 10 is less than electric power generated by the electric motor 17, it is possible to decrease a rate of increase of the remaining capacity of the power storage device 16.

The controller 15 can simultaneously perform the heating operation and the cooling operation when the vehicle interior temperature T3 which is requested by a user of the motor-driven vehicle Ve is equal to or higher than the first predetermined temperature T1 and lower than the second predetermined temperature T2. Specifically, the controller 15 can perform control such that the heating operation of heating the heat-radiating unit 58 of the first indoor heat exchanger 61 and the cooling operation of decompressing a refrigerant using the second expansion valve 27 can be simultaneously performed.

In this case, by simultaneously performing the cooling operation of decompressing a refrigerant using the second expansion valve 27 in the heating operation in which the heat-radiating unit 58 is heated, it is possible to decrease a heating efficiency in the heating operation. Accordingly, in order to obtain the same efficiency as before the power waste control has been performed in the heating operation under the power waste control, it is possible to increase the power consumption of the vehicular air conditioner 10 (see Graph G11).

On the other hand, by simultaneously performing the heating operation of heating the heat-radiating unit 58 in the cooling operation of decompressing a refrigerant using the second expansion valve 27, it is possible to decrease a cooling efficiency in the cooling operation. Accordingly, in order to obtain the same efficiency as before the power waste control has been performed in the cooling operation under the power waste control, it is possible to increase the power consumption of the vehicular air conditioner 10 (see Graph G11).

When the remaining capacity of the power storage device 16 is equal to or greater than a predetermined value, the controller 15 can decrease an operation efficiency of the refrigerant circuit 13 in comparison with that when the remaining capacity of the power storage device 16 is less than the predetermined value.

Specifically, the first to sixth power waste controls in the heating operation illustrated in FIGS. 4 to 19 can be exemplified regarding the operation efficiency of the refrigerant circuit 13. By performing the first to sixth power waste controls, it is possible to decrease the heating efficiency in the heating operation.

The seventh to eleventh power waste controls in the cooling operation illustrated in FIGS. 21 to 26 can be exemplified regarding the operation efficiency of the refrigerant circuit 13. By performing the seventh to eleventh power waste controls, it is possible to decrease the cooling efficiency in the cooling operation.

Accordingly, in order to obtain the same efficiency as before the power waste control has been performed in the heating operation or the cooling operation, it is possible to increase the power consumption of the vehicular air conditioner 10.

An example in which the power waste control is performed when the predetermined temperature (the vehicle interior temperature) which is requested by a user of the motor-driven vehicle Ve is less than the first predetermined temperature T1 and equal to or greater than the second predetermined temperature T2 in a state in which the vehicular air conditioner 10 operates will be described.

The controller 15 performs control such that the heating operation is performed when the vehicle interior temperature which is requested by a user of the motor-driven vehicle Ve is less than the first predetermined temperature T1. By performing the heating operation, the first indoor heat exchanger 61 is controlled such that it is heated.

Specifically, an operation of heating the indoor condenser 55 of the first indoor heat exchanger 61 by decompressing the refrigerant using the first expansion valve 22 and heating the heat-radiating unit 58 of the first indoor heat exchanger 61 is performed as the heating operation. Alternatively, one of an operation of heating the indoor condenser 55 by decompressing the refrigerant using the first expansion valve 22 and an operation of heating the heat-radiating unit 58 is performed as the heating operation.

On the other hand, the controller 15 performs control such that the cooling operation is performed when the vehicle interior temperature is equal to or greater than the second predetermined temperature T2. Specifically, an operation of decompressing the refrigerant using the second expansion valve 27 is performed as the cooling operation.

Accordingly, outside the range of the temperature difference S1 between the first predetermined temperature T1 and the second predetermined temperature T2, it is possible to perform the cooling operation or the heating operation with priority given to the request from a user. Accordingly, it is possible to adjust the vehicle interior temperature in response to a request from a user and to secure (maintain) marketability of the vehicular air conditioner 10.

An example in which the temperature difference S1 between the first predetermined temperature T1 and the second predetermined temperature T2 is controlled when the remaining capacity of the power storage device 16 is less than a predetermined value and when the remaining capacity of the power storage device 16 is equal to or greater than a predetermined value in a state in which the motor-driven vehicle Ve is operating will be described below.

By performing the heating operation at a temperature lower than the first predetermined temperature T1 and performing the cooling operation at a temperature equal to or higher than the second predetermined temperature T2, it is possible to increase the heating efficiency and the cooling efficiency in the operations and to decrease the power consumption of the vehicular air conditioner 10.

Therefore, when the remaining capacity of the power storage device 16 is less than a predetermined value, the controller 15 performs control such that the temperature difference S1 between the first predetermined temperature T1 and the second predetermined temperature T2 is decreased to narrow the range in which the cooling operation and the heating operation are performed together. Accordingly, transition to only the heating operation or the cooling operation can be facilitated and the frequency in which only the heating operation or only the cooling operation is performed can be secured as many as possible. As a result, when the remaining capacity of the power storage device 16 is less than a predetermined value, it is possible to increase the heating efficiency and the cooling efficiency of the vehicular air conditioner 10 and to decrease the power consumption of the vehicular air conditioner 10.

On the other hand, the controller 15 performs control such that the cooling operation and the heating operation are performed together within the range of the temperature difference S1 between the first predetermined temperature T1 and the second predetermined temperature T2 as described above. By using the cooling operation and the heating operation together, it is possible to decrease the cooling efficiency in the cooling operation and to decrease the heating efficiency in the heating operation. Accordingly, it is possible to increase the power consumption of the vehicular air conditioner 10 (see Graph G9).

Therefore, when the remaining capacity of the power storage device 16 is equal to or greater than a predetermined value, the controller 15 performs control such that the temperature difference S1 between the first predetermined temperature T1 and the second predetermined temperature T2 is increased to broaden the range in which the cooling operation and the heating operation are performed together. Accordingly, transition to only the heating operation or the cooling operation can be made to be difficult and the frequency in which the heating operation and the cooling operation are performed together can be secured as many as possible. As a result, when the remaining capacity of the power storage device 16 is equal to or greater than a predetermined value, it is possible to decrease the heating efficiency and the cooling efficiency of the vehicular air conditioner 10 and to increase the power consumption of the vehicular air conditioner 10.

In this way, when the remaining capacity of the power storage device 16 is equal to or greater than a predetermined value, the temperature difference S1 between the first predetermined temperature T1 and the second predetermined temperature T2 is set to be greater than that when the remaining capacity of the power storage device 16 is less than a predetermined value. Accordingly, it is possible to freely control the power consumption of the vehicular air conditioner 10 to correspond to when the remaining capacity of the power storage device 16 is less than a predetermined value and when the remaining capacity of the power storage device 16 is equal to or greater than a predetermined value.

When the remaining capacity of the power storage device 16 is equal to or greater than a predetermined value, the temperature difference S1 between the first predetermined temperature T1 and the second predetermined temperature T2 may be gradually changed to correspond to an increase or a decrease in the remaining capacity of the power storage device 16.

For example, it is possible to gradually increase the temperature difference S1 between the first predetermined temperature T1 and the second predetermined temperature T2 to correspond to an increase in the remaining capacity of the power storage device 16. In addition, it is possible to gradually decrease the temperature difference S1 between the first predetermined temperature T1 and the second predetermined temperature T2 to correspond to a decrease in the remaining capacity of the power storage device 16.

Accordingly, when the remaining capacity of the power storage device 16 is equal to or greater than a predetermined value, it is possible to change the range in which the first operation and the second operation are used together to correspond to an increase or a decrease in the remaining capacity of the power storage device 16. Accordingly, it is possible to efficiently decrease the air-conditioning efficiency to correspond to an increase or a decrease in the remaining capacity and to increase the power consumption of the air conditioner.

In the range of the temperature difference S1 between the first predetermined temperature T1 and the second predetermined temperature T2 illustrated in FIG. 28, a dehumidifying and cooling operation (that is, the first operation) using the vehicular air conditioner 10 and a dehumidifying and heating operation (that is, the second operation) may be switched to each other. Accordingly, when the remaining capacity of the power storage device 16 is equal to or greater than a predetermined value, it is possible to increase the power consumption of the vehicular air conditioner 10 by switching the dehumidifying and cooling operation and the dehumidifying and heating operation to each other.

That is, it is possible to decrease a dehumidifying and heating efficiency, for example, by switching the dehumidifying and heating operation to the dehumidifying and cooling operation with the predetermined temperature T3 as a threshold. Accordingly, in order to obtain the same dehumidifying and heating capability as before the power waste control has been performed in the dehumidifying and heating operation, it is possible to increase the power consumption of the vehicular air conditioner 10.

On the other hand, it is possible to decrease a dehumidifying and cooling efficiency, for example, by switching the dehumidifying and cooling operation to the dehumidifying and heating operation with the predetermined temperature T3 as a threshold. Accordingly, in order to obtain the same dehumidifying and cooling capability as before the power waste control has been performed in the dehumidifying and cooling operation, it is possible to increase the power consumption of the vehicular air conditioner 10.

When the power consumption of the vehicular air conditioner 10 is greater than electric power generated by the electric motor 17 in a state in which the power consumption of the vehicular air conditioner 10 has been increased in this way, it is possible to prevent overcharging of the power storage device 16. When the power consumption of the vehicular air conditioner 10 is less than electric power generated by the electric motor 17, it is possible to decrease a rate of increase of the remaining capacity of the power storage device 16.

The technical scope of the invention is not limited to the above-mentioned embodiment, and various modifications are possible without departing from the gist of the invention.

For example, an electric vehicle is exemplified as a motor-driven vehicle in the above-mentioned embodiment, but the invention is not limited thereto. The invention may be applied to, for example, a hybrid vehicle and a fuel-cell vehicle as other vehicles.

In the above-mentioned embodiment, the predetermined temperature T3 is set to a vehicle interior temperature which is requested by a user, but the invention is not limited thereto. For example, the predetermined temperature T3 may be set to an outdoor air temperature or a vehicle interior temperature (which does not include a request from a user).

Accordingly, for example, when the outdoor air temperature is lower than the first predetermined temperature, the second operation (that is, the heating operation) based on decompression by the first expansion valve 22 can be performed and the interior temperature can be appropriately maintained to correspond to the outdoor air temperature. When the outdoor air temperature is equal to or higher than the second predetermined temperature, the first operation (that is, the cooling operation) based on decompression by the second expansion valve 27 can be performed and the interior temperature can be appropriately maintained to correspond to the outdoor air temperature. Accordingly, it is possible to appropriately maintain the interior temperature to correspond to the outdoor air temperature and to secure (maintain) marketability of a motor-driven vehicle Ve.

When the vehicle interior temperature is lower than the first predetermined temperature, the second operation based on decompression by the first expansion valve 22 can be performed and the vehicle interior temperature can be appropriately maintained. When the vehicle interior temperature is equal to or higher than the second predetermined temperature, the first operation based on decompression by the second expansion valve 27 can be performed and the vehicle interior temperature can be appropriately maintained. Accordingly, it is possible to appropriately maintain the vehicle interior temperature and to secure (maintain) marketability of a motor-driven vehicle Ve.

In the above-mentioned embodiment, when the vehicle interior temperature T3 which is requested by a user is equal to or higher than the first predetermined temperature T1 and lower than the second predetermined temperature T2 and the heating operation and the cooling operation can be simultaneously performed, the heating operation is performed by heating the heat-radiating unit 58 of the first indoor heat exchanger 61, but the invention is not limited thereto.

For example, a configuration in which the indoor condenser 55 of the first indoor heat exchanger 61 is heated may be employed.

What is claimed is:

1. A motor-driven vehicle that comprises:
an electric motor;
a power storage device that is electrically connected to the electric motor; and
a controller that controls the electric motor and the power storage device, the motor-driven vehicle comprising
a refrigerant circuit which includes:
a compressor that compresses and discharges an intake refrigerant;
an outdoor heat exchanger that causes the refrigerant to exchange heat with outdoor air;
a first indoor heat exchanger that is disposed between the compressor and the outdoor heat exchanger and causes the refrigerant to exchange heat with indoor air;
a first expansion valve that is disposed between the first indoor heat exchanger and the outdoor heat exchanger and is able to decompress the refrigerant;
a second expansion valve that is disposed between the outdoor heat exchanger and the compressor and is able to decompress the refrigerant; and
a second indoor heat exchanger that is disposed between the second expansion valve and the compressor and causes the refrigerant to exchange heat with indoor air,
wherein the controller changes a ratio of an amount of pressure reduction of the second expansion valve to an amount of pressure reduction of the first expansion valve with a predetermined temperature as a boundary when a remaining capacity of the power storage device is equal to or greater than a predetermined value.

2. The motor-driven vehicle according to claim 1,
wherein the predetermined temperature includes a first predetermined temperature and a second predetermined temperature which is higher than the first predetermined temperature, and
wherein the controller simultaneously performs heating using the first indoor heat exchanger and decompression using the second expansion valve when a vehicle interior temperature which is requested by a user of the motor-driven vehicle is equal to or higher than the first predetermined temperature and less than the second predetermined temperature.

3. The motor-driven vehicle according to claim 2,
wherein the controller allows an operation efficiency of the refrigerant circuit to be less when the remaining capacity is equal to or greater than the predetermined value than when the remaining capacity is less than the predetermined value.

4. The motor-driven vehicle according to claim 2,
wherein the predetermined temperature includes a first predetermined temperature and a second predetermined temperature which is higher than the first predetermined temperature, and
wherein the controller performs decompression using the first expansion valve when the vehicle interior temperature which is requested by the user of the motor-driven vehicle is less than the first predetermined temperature, and performs decompression using the second expansion valve when the vehicle interior temperature which is requested by the user of the motor-driven vehicle is equal to or greater than the second predetermined temperature.

5. The motor-driven vehicle according to claim 2,
wherein the predetermined temperature includes a first predetermined temperature and a second predetermined temperature which is higher than the first predetermined temperature, and
wherein the controller performs decompression using the first expansion valve when an outdoor air temperature of the motor-driven vehicle is less than the first predetermined temperature, and performs decompression using the second expansion valve when the outdoor air temperature of the motor-driven vehicle is equal to or greater than the second predetermined temperature.

6. The motor-driven vehicle according to claim 2,
wherein the predetermined temperature includes a first predetermined temperature and a second predetermined temperature which is higher than the first predetermined temperature, and
wherein the controller performs decompression using the first expansion valve when the vehicle interior temperature of the motor-driven vehicle is less than the first predetermined temperature, and performs decompression using the second expansion valve when the vehicle interior temperature of the motor-driven vehicle is equal to or greater than the second predetermined temperature.

7. The motor-driven vehicle according to claim 1,
wherein the predetermined temperature includes a first predetermined temperature and a second predetermined temperature which is higher than the first predetermined temperature, and
wherein a temperature difference between the first predetermined temperature and the second predetermined temperature when the remaining capacity is equal to or greater than the predetermined value is greater than a temperature difference between the first predetermined temperature and the second predetermined temperature when the remaining capacity is less than the predetermined value.

8. The motor-driven vehicle according to claim 1,
wherein the predetermined temperature includes a first predetermined temperature and a second predetermined temperature which is higher than the first predetermined temperature, and
wherein a temperature difference between the first predetermined temperature and the second predetermined temperature is increased based on an increase in the remaining capacity when the remaining capacity is equal to or greater than the predetermined value.
